(19) United States
(12) Patent Application Publication
(10) Pub. No.: US 2014/0016598 A1
(43) Pub. Date: Jan. 16, 2014

(54) DEVICE AND METHOD FOR TRANSMITTING CONTROL INFORMATION FOR INTER-HETEROGENEOUS CELL INTERFERENCE ADJUSTMENT IN A WIRELESS COMMUNICATION SYSTEM

(71) Applicants: Ki Bum Kwon, Seoul (KR); Si Hyung Kim, Seoul (KR)

(72) Inventors: Ki Bum Kwon, Seoul (KR); Si Hyung Kim, Seoul (KR)

(21) Appl. No.: 14/009,450

(22) PCT Filed: Apr. 2, 2012
(86) PCT No.: PCT/KR2012/002447

§ 371 Date: Oct. 2, 2013

(30) Foreign Application Priority Data
Apr. 2, 2011 (KR) 10-2011-0030438

(51) Int. Cl. H04L 5/00

(52) U.S. Cl. CPC H04L 5/0073
USPC 370/329

(57) ABSTRACT

The present invention relates to a device and method for transmitting control information for inter-heterogeneous cell interference adjustment in a wireless communication system. The present invention relates to a base station including: a signal receiving unit for receiving an ABS pattern; a system information generating unit for generating separation information that notifies the separated distance from a first sub frame transmitting PDCCH on the basis of the ABS pattern to a second sub frame transmitting PDSCH scheduled by the PDCCH; a downlink control information generating unit for generating downlink control information including a scheduling offset which indicates the separated distance; and a signal transmitting unit for transmitting the downlink control information from the first sub frame and transmitting a paging message or system information from the second sub frame.

### CROSS-REFERENCE TO RELATED APPLICATIONS

This application is the National Stage Entry of International Application PCT/KR2012/002447, filed on Apr. 2, 2012, and claims priority from and the benefit of Korean Patent Application no. 10-2011-0030438, filed on Apr. 2, 2011, both of which are incorporated herein by reference in their entireties for all purposes as if fully set forth herein.

### BACKGROUND

1. Field

The present invention concerns wireless communication, and more specifically, to an apparatus and method for transmitting control information for coordinating interference between heterogeneous cells in a wireless communication system.

2. Discussion of the Background

3GPP (3^{rd} Generation Partnership Project) LTE (Long Term Evolution) that is an advanced version of UMTS (Universal Mobile Telecommunications System) is introduced in the 3GPP release 8. The 3GPP LTE uses OFDAM (Orthogonal Frequency Division Multiple Access) for downlink and SC-FDMA (Single Carrier-frequency Division Multiple Access) for uplink. It adopts MIMO (Multiple Input Multiple Output) with up to four antennas. Recently, 3GPP LTE-A (LTE-Advanced) that evolves from 3GPP LTE is in discussion.

As wireless communication technologies grow, a heterogeneous network environment rises accordingly.

In the heterogeneous network environment, macro cells, femto cells, and pico cells are mixed up together. Compared with the macro cell, the femto cell or pico cell covers an area with smaller service coverage than that of an existing mobile communication service.

In such a communication system, a user equipment that is positioned in one of a macro cell, a femto cell, and a pico cell is encountered with inter-cell interference that is caused by signals coming from other cells. In particular, when a user equipment communication with a macro cell enters into an interference area of a femto cell, the user equipment may not properly receive a paging message or system information from the macro cell.

### SUMMARY

An object of the present invention is to provide an apparatus and method for transmitting control information for coordinating interference between heterogeneous cells in a wireless communication system.

Another object of the present invention is to provide an apparatus and method for transmitting a PDSCH associated with a PDCCH in different sub-frames.

Still another object of the present invention is to provide an apparatus and method for generating a scheduling offset by analyzing an ABS pattern.

Yet still another object of the present invention is to provide an apparatus and method for coordinating interference of a PDCCH between heterogeneous cells based on an ABS pattern.

Yet still another object of the present invention is to provide an apparatus and method for transmitting a paging message or system information using a scheme of coordinating interference between heterogeneous cells based on TDM and FDM.

According to an aspect of the present invention, a base station is provided that transmits control information for coordinating inter-heterogeneous cell interference. The base station includes a signal receiving unit that receives a pattern of a sub-frame (almost blank sub-frame: hereinafter, “ABS”) emptied to be restricted in use by a heterogeneous eNB based on time division multiplexing, a system information generating unit that generates separation information indicating a separated distance between a first sub-frame where a physical downlink control channel (hereinafter, “PDCCH”) is transmitted based on the ABS pattern and a second sub-frame where a physical downlink shared channel (hereinafter, “PDSCH”) scheduled by the PDCCH is transmitted, a downlink control information generating unit that generates downlink control information including a scheduling offset indicating the separated distance, and a signal transmitting unit that transmits the downlink control information in the first sub-frame and transmits a paging message or system information in the second sub-frame.

According to another aspect of the present invention, a method of transmitting control information for coordinating inter-heterogeneous cell interference is provided. The method comprises receiving a pattern (ABS) of a sub-frame emptied to be restricted in use by a heterogeneous eNB based on time division multiplexing, obtaining a separated distance between a first sub-frame where a PDCCH is transmitted based on the ABS pattern and a second sub-frame where a PDSCH scheduled by the PDCCH is transmitted, generating downlink control information including a scheduling offset indicating the separated distance, transmitting the downlink control information in the first sub-frame, and transmitting a paging message or system information in the second sub-frame.

According to still another aspect of the present invention, a user equipment is provided that receives control information for coordinating inter-heterogeneous cell interference. The user equipment a physical channel receiving unit that receives a PDCCH in a first sub-frame that is not set as a pattern (ABS) of a sub-frame emptied to be restricted in use by a heterogeneous eNB based on time division multiplexing, receives a PDSCH indicated by the PDCCH in a second sub-frame set as an ABS, and receives separation information indicating a distance between the first sub-frame and the second sub-frame through a PBCH, and a system updating unit that updates the system based on the separation information.

According to yet still another aspect of the present invention, a method of receiving control information for coordinating inter-heterogeneous cell interference is provided. The method comprises receiving a PDCCH in a first sub-frame that is not set as a pattern (ABS) of a sub-frame emptied to be restricted in use by a heterogeneous eNB based on time division multiplexing, receiving a PDSCH indicated by the PDCCH in a second sub-frame set as an ABS, receiving, through a PBCH, separation information indicating a distance between the first sub-frame and the second sub-frame, and updating the system based on the separation information.

According to the present invention, in case TDM or FDM is used to control interference in a heterogeneous wireless network system in which various types of cells, such as macro cells, micro cells, pico cells, and femto cells co-exist, a user equipment that is in an RRC idle state may easily receive a paging message and system information of an aggressor cell or a victim cell.

### BRIEF DESCRIPTION OF THE DRAWINGS

FIG. 1 illustrates a wireless communication system to which the present invention applies;

FIG. 2 is a view illustrating a process of selecting a cell by a user equipment that is in an RRC idle state according to the present invention;

FIG. 3 is a view schematically illustrating the concept of a heterogeneous network that is constituted of macro base stations, femto base stations, and pico base stations according to the present invention;

FIG. 4 is a view schematically illustrating an example in which user equipments are influenced by interference between a macro cell, a femto cell, and a pico cell on downlink;

FIG. 5 is a view illustrating a frame pattern for inter-cell interference coordination in a heterogeneous network system according to an embodiment of the present invention;

FIG. 6 is a flowchart illustrating a method of transmitting control information for coordinating inter-heterogeneous cell interference according to an embodiment of the present invention;

FIG. 7 illustrates an example to which a method of transmitting control information for coordinating inter-heterogeneous cell interference is applied according to the present invention;

FIG. 8 illustrates another example to which a method of transmitting control information for coordinating inter-heterogeneous cell interference according to the present invention is applied;

FIG. 9 illustrates another example to which a method of transmitting control information for coordinating inter-heterogeneous cell interference according to the present invention is applied;

FIG. 10 is a flowchart illustrating a method of receiving control information for coordinating inter-heterogeneous cell interference by a user equipment according to an embodiment of the present invention;

FIG. 11 is a flowchart illustrating a method of transmitting control information for coordinating inter-heterogeneous cell interference by an aggressor cell according to an embodiment of the present invention;

FIG. 12 is a flowchart illustrating a method of transmitting control information for coordinating inter-heterogeneous cell interference by a victim cell according to an embodiment of the present invention; and

FIG. 13 is a flowchart illustrating signaling between a femto base station and an operation and management device according to an embodiment of the present invention.

FIG. 14 is a block diagram illustrating a user equipment and a base station according to an embodiment of the present invention.

### DETAILED DESCRIPTION OF THE ILLUSTRATED EMBODIMENTS

Embodiments of the present invention will be described in detail with reference to the accompanying drawings. The same denotations may be used to refer to the same or similar elements throughout the drawings and the specification. When determined to make the subject matter of the present invention unclear, the detailed description of the prior art will be skipped.

The instant disclosure is targeted for a wireless communication network. A task that is done in the wireless communication network may be performed while a system (for example, a base station) managing the wireless communication network controls the network and transmits data or the task may be conducted by a user equipment associated with the wireless network.

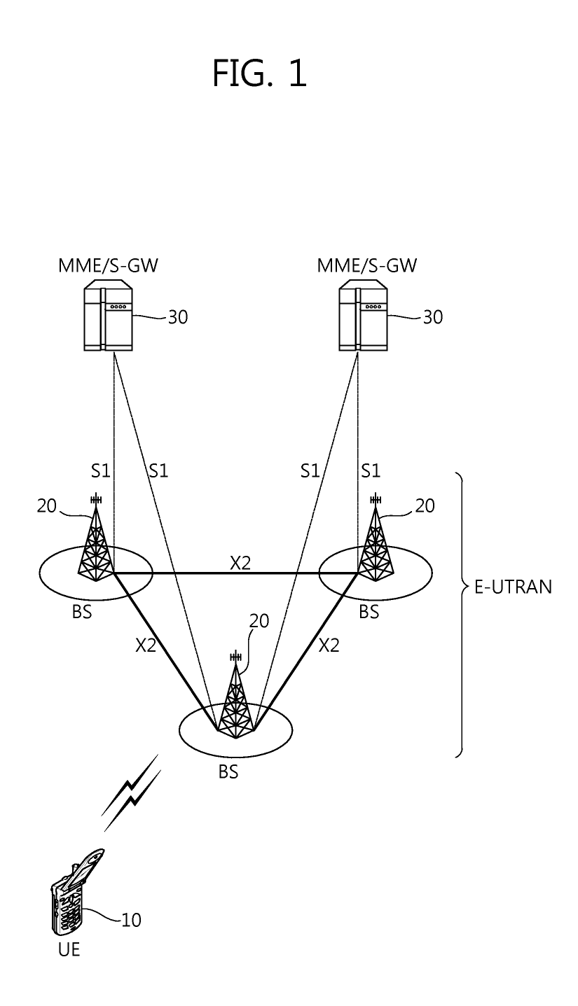

FIG. 1 illustrates a wireless communication system to which the present invention applies. This may also be referred to as “E-UTRAN (Evolved-UMTS Terrestrial Radio Access Network) or LTE (Long Term Evolution)/LTE-A.”

Referring to FIG. 1, the E-UTRAN includes a base station (BS) 20 that provides a user equipment (UE) 10 with a control plane and a user plane. The UE 10 may be stationary or mobile and may be referred to as “MS (Mobile Station),” “UT (User Terminal),” “SS (Subscriber Station),” “MT (Mobile Terminal,” and “wireless device.” The base station 20 is a station that communicates with the UE 10 and may be referred to as “eNB (evolved-NodeB),” “BTS (Base Transceiver System),” “access point,” “home eNB,” “relay,” and “remote radio head (RRH).”

Base stations 20 may be connected to each other via an X2 interface. Each base station 20 is connected to an MME (Mobility Management Entity) via an EPC (Evolved Packet Core) 30, more specifically S1-MME and to an S-GW (Serving Gateway) via an S1-U. The S1 interface provides/receives OAM (Operation and Management) information for supporting mobility of the UE 10 to/from the MME by exchanging signals with the MME.

An EPC 30 consists of an MME, an S-GW, and a P-GW (Packet Data Network-Gateway). The MME contains access information of the UE 10 or information on the capability of the UE 10. Such information is mainly used for managing the mobility of the UE 10. The S-GW is a gateway having an E-UTRAN as its end point, and the P-GW is a gateway having a PDN as its end point.

Layers of a radio interface protocol between the UE 10 and the network may be classified into L1 (first layer), L2 (second layer), and L3 (third layer) based on lower three layers of the well-known open system interconnection (OSI) standard model in the communication system. Among the three layers, a physical layer that belongs to the first layer provides an information transfer service using a physical channel, and an RRC (Radio Resource Control) layer that is positioned in the third layer serves to control a radio resource between the UE 10 and the network. For this, the RRC layer exchanges RRC messages between the UE 10 and the base station.

The physical layer (PHY) provides a higher layer with an information transfer service using a physical channel. The physical layer is connected to the MAC (Medium Access Control) layer that belongs to the second layer via a transfer channel. Data travels between the MAC layer and the physical layer through the transfer channel. Transfer channels are classified depending on how data is transferred through a radio interface.

Between different physical layers, i.e., between the physical layer of the transmitter and the physical layer of the receiver is transferred data via a physical channel. The physical channel is modulated in an OFDM (Orthogonal Frequency Division Multiplexing) scheme, and the physical channel utilizes time and frequency as radio resources.

The functions of the MAC layer include multiplexing/de-multiplexing of MAC SDUs (service data units) belonging to a logical channel into transport blocks provided to the physical channel over the transfer channel and m aping between the logical channel and transfer channel. The MAC layer provides a service to an RLC (Radio Link Control) layer through the logical channel.

The functions of the RLC layer belonging to the second layer include concatenation, sementation, and reassembly of RLC SDUs. To insure various QoSs (Quality of Services) required by radio bearers (RB), the RLC layer provides three operation modes including a transparent mode (TM), an unacknowledged mode (UM), and an acknowledged mode (AM). The AM RLC provides error correction through an ARQ (Automatic Repeat Request).

The functions of a PDCP (Packet Data Convergence Protocol) layer on the user plane include transfer of user data, header compression, and ciphering. The functions of a PDCP (Packet Data Convergence Protocol) layer on the user plane include transfer of control plane data and ciphering/integrity protection.

The RRC (Radio Resource Control) layer that belongs to the third layer is defined only on the control plane. The RRC layer is in charge of control of the logical channel, transfer channel, and physical channels in association with configuration, re-configuration, and release of radio bearers. The RB means a logical path that is provided by the first layer (PHY layer) and second layer (MAC layer, RRC layer, and PDCP layer) for transferring data between the UE 10 and the network. “RB being configured” means a process of specifying the features of the wireless protocol layers and channels for providing a particular service and configuring specific parameters and operation methods of each thereof. The RBs may be separated into two types: SRBs (Signaling RBs) and DRBs (Data RBs). The SRB is used as a path through which an RRC message passes, and the DRB is used as a path for transmitting user data on the user plane.

In case there is an RRC connection between the RRC layer of the UE 10 and the RRC layer of the E-UTRAN, the UE 10 is in an RRC connected state, and is otherwise in an RRC idle state.

Downlink transfer channels for transmitting data from the network to the UE 10 include a BCH (Broadcast Channel) for transmitting system information and a downlink SCH (Shared Channel) for transmitting other user traffic or control messages. Traffic or control messages of a downlink multicast or broadcast service may be transmitted through the downlink SCH or via a separate downlink MCH (Multicast Channel). Meanwhile, uplink transfer channels for transmitting data from the UE 10 to the network include an RACH (Random Access Channel) for transmitting an initial control message and an uplink SCH (Shared Channel) for transmitting other user traffic or control messages.

Logical channels that are positioned over the transfer channel and that are mapped with the transfer channel include a BCCH (Broadcast Control Channel), a PCCH (Paging Control Channel), a CCCH (Common Control Channel), an MCCH (Multicast Control Channel), and an MTCH (Multicast Traffic Channel).

The pico cell consists of a number of symbols in the time domain and a number of sub-carriers in the frequency domain. One sub-frame consists of a plurality of resource blocks, and one resource block consists of a plurality of symbols and a plurality of sub-carriers. Further, each sub-frame may use specific sub-carriers of specific symbols (e.g., a first symbol) of a corresponding sub-frame for a physical control channel, a PDCCH (Physical Downlink Control Channel). A TTI (Transmission Time Interval) that is a unit time during which data is transmitted is 1 ms that corresponds to one sub-frame.

Hereinafter, the RRC state of a user equipment and an RRC connection method are described in detail.

The RRC state means whether the RRC layer of the user equipment maintains a logical connection with the RRC layer of an E-UTRAN, and when maintaining the connection is referred to as the “RRC connected state,” and when not maintaining the connection is referred to as the “RRC idle state.” When in the RRC connected state, the user equipment has an RRC connection, and thus, the E-UTRAN may figure out the presence of the corresponding user equipment on a cell-basis. Accordingly, the E-UTRAN may effectively control the user equipment. On the contrary, when in the RRC idle state, the user equipment is not figured out by the E-UTRAN, and is managed by a core network on the basis of a tracking area that is a larger area unit than a cell. That is, whether there is a user equipment that remains in the RRC idle state is figured out only on the basis of a large area, and a shift to the RRC connected state should be done to receive a common mobile communication service such as voice and data.

When a user first powers on the user equipment, the user equipment attempts to gain access to a PLMN (Public Land Mobile Network). The specific PLMN accessed may be selected automatically or manually. Here, the PLMN refers to a wireless communication system to be used by a user who is in a vehicle or is walking on the road. Or, the PLMN may denote all mobile wireless networks that use a terrestrial base station other than satellites. A home PLMN is a PLMN that has an MCC (Mobile County Code) and an MNC (Mobile Network Code) identical to the MCC, which are included an IMSI (International Mobile Subscriber Identity) that is a unique 15-digit code used for identifying an individual user of a GSM (Global System for Mobile Communication) network. An equivalent HPLMN list (EHPLMN) refers to a PLMN code list that replaces an HPLMN code extracted from the IMSI for permitting the provision of multiple HPLMN codes. The EHPLMN list is stored in a USIM (Universal Subscriber Identity Module). The EHPLMN list may include an HPLMN code extracted from the IMSI. If the HPLMN code extracted from the IMSI is not in the EHPLMN list, the HPLMN should be treated as a visited PLMN upon selection of the PLMN. The visited PLMN is a PLMN having an HPLMN and an EHPLMN (if any) different from the HPLMN. A registered PLMN (RPLMN) is a PLMN in which some LR results occur. In general, in a shared network, the RPLMN is a PLMN defined by a PLMN of an operator of a core network that permits LR.

The user equipment explores a proper cell of the selected PLMN and then stays in the RRC idle state in the corresponding cell. The user equipment that is in the RRC idle state selects a cell that may provide available services and performs coordination to fit for the control channel of the selected cell. This process is referred to as “camp on a cell.” If the camp on is complete, the user equipment may register itself in a registration area of the selected cell. This is referred to as “location registration (LR).” The user equipment regularly registers itself in the registration area or registers itself when entering into a new tracking area (TA). The registration area refers to any area where the user equipment may roam without performing a location registration process.

In case the user equipment departs from the service area of the cell or discovers a more proper cell, the user equipment re-selects the most proper cell in the PLMN and camps on. If the new cell is included in other registration area, a request for location registration is conducted. If the user equipment departs from the service area of the PLMN, a new PLMN may be selected automatically or manually by a user.

For the following purposes, the user equipment that is in the RRC idle state proceeds with camp-on.

1) User equipment receives system information from the PLMN

2) After initializing a call, the user equipment first accesses a network through the control channel of the camped-on cell

3) Receiving a paging message: in case the PLMN receives a call for the user equipment, the PLMN is aware of the registration area of the cell where the user equipment camps on. Accordingly, the PLMN may send a paging message for the user equipment through the control channels of all of the cells that are present in the registration area. The user equipment has been subjected to coordination to fit for the control channel of the camped-on cell, and may thus receive a paging message.

4) Receiving a broadcasting message of a cell

If the user equipment fails to discover a cell proper for camp-on or no SIM (Subscriber Identity Module) card is inserted into the user equipment or in case the user equipment receives a specific response to a request for location registration (for example, “illegal user equipment”), the user equipment attempts to camp on regardless of the PLMN and enters into a “restricted service” state. In the restricted service state, only an emergency call is possible.

The user equipment that is in the RRC idle state, when an RRC connection needs to be established, establishes an RRC connection with the E-UTRAN through an RRC connection procedure and shifts to an RRC connection state. There are a number of situations in which the user equipment that is in the RRC idle state needs to establish an RRC connection—for example, when uplink data transmission is needed, e.g., for the reason of a user's attempt to make a call or when a paging message is received from the E-UTRAN.

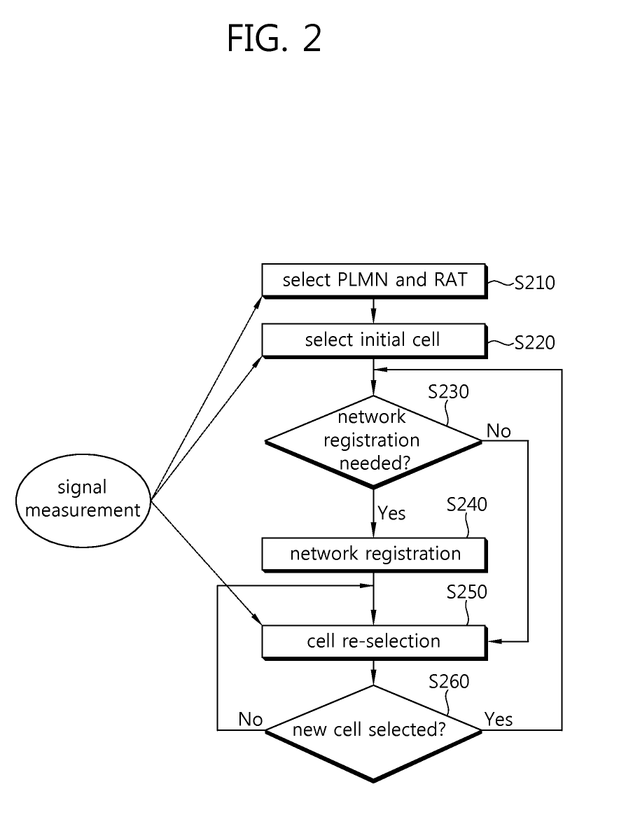

FIG. 2 is a view illustrating a process of selecting a cell by a user equipment that is in an RRC idle state according to the present invention.

Referring to FIG. 2, the user equipment selects a PLMN and an RAT (Radio Access Technology) from which the user equipment is to receive a service (S210). The PLMN and RAT may be selected by the user of the user equipment, or a PLMN and a RAT stored in the USIM may be used as the PLMN and RAT.

The user equipment selects a cell having the largest signal strength or quality value among cells whose signal strengths or quality values are larger than a predetermined value (S220). The user equipment receives system information that is periodically transmitted from a base station. The predetermined value is a value defined in the system for ensuring the quality for a physical signal upon transmission/reception of data. Accordingly, the predetermined value may vary depending on the RAT as applied.

The user equipment determines whether registration to a network is needed (S230), and if needed, registers its information (e.g., IMSI) to receive a service (e.g., paging) from the network (S240). The user equipment does not perform registration to the network which the user equipment is to access whenever selecting a cell. For example, in case system information (e.g., tracking area identity; TAI) of the network to which registration is performed is different from the information of the network that is known to the user equipment, registration to the network is performed.

If the signal strength or quality value measured from the base station from which the user equipment is receiving a service is lower than a value measured from a base station of an adjacent cell, the user equipment selects a cell providing better signal characteristics than those provided by the cell of the base station to which the user equipment is connected (S250). This process is referred to as cell reselection that is separated from the initial cell selection of step S220. At this time, a temporal limitation may be included to prevent the cell reselection from occurring frequently according to changes in signal characteristics.

Next, a procedure of selecting a cell by a user equipment is described in detail.

When the user equipment powers on or remains in a cell, the user equipment performs procedures for receiving services by selecting/reselecting a cell having a proper quality.

The user equipment that is in the RRC idle state should select a cell having a proper quality and should be always ready to receive a service through the selected cell. For example, immediately upon power-on, the user equipment should select a cell having a proper quality to register in a network. If the user equipment that is in the RRC connection state enters into the RRC idle state, the user equipment should select a cell where the user equipment is to stay in the RRC idle state. As such, a process of the user equipment selecting a cell satisfying some conditions so that the user equipment stays in a service stand-by state, such as the RRC idle state, is referred to as cell selection. The cell selection is performed while the user equipment currently fails to determine a cell where the user equipment is to stay in the RRC idle state. Thus, it is critical to select a cell as fast as possible, among others. Accordingly, any cell that provides a radio signal quality higher than a predetermined reference value, even when the cell does not provide the best radio signal quality to the user equipment, may be selected during the cell selecting process.

The cell selecting process may be separated into two types.

First, an initial cell selecting process. In this process, the user equipment does not have previous information on a radio channel. Accordingly, the user equipment searches all radio channels to discover a proper cell. The user equipment finds out the strongest cell for each channel. Thereafter, once the user equipment finds a proper cell that satisfies a cell selection reference, the user equipment selects the corresponding cell.

The other one is a cell selecting process using stored information. In this process, information stored in the user equipment for a radio channel is utilized or information that is being broadcast in the cell is utilized to select a cell. Accordingly, as compared with the initial cell selecting process, cell selection may be performed quickly. Once the user equipment finds a cell satisfying a cell selection reference, the user equipment selects the corresponding cell. If through this process, the user equipment fails to discover a proper cell satisfying the cell selection reference, the user equipment performs the initial selecting process.

The cell selection reference used by the user equipment in the cell selecting process is as shown in Equation 1:

Srxlev>0 and Squal>0 [Equation 1]

Here, Srxlev=Qᵣₓₗₑᵥₘₑₐₛ−(Qᵣₓₗₑᵥₘᵢₙ+Q_{rxlevminoffset})+Pcompensation. Qᵣₓₗₑᵥₘₑₐₛ is a reception level (RSRP) of a measured cell, Qᵣₓₗₑᵥₘᵢₙ is a minimum necessary reception level (dBm) in a cell, Q_{rxlevminoffset} is an offset for Qᵣₓₗₑᵥₘᵢₙ, Pcompensation=max(P_{EMAX}−P_{UMAX}, 0) (dB), P_{EMAX} is a maximum transmission power (dBm) that may be transmitted from the user equipment in the corresponding cell), P_{UMAX} is a maximum transmission power (dBm) of a user equipment wireless transmitting unit (RF) depending on the performance of the user equipment.

From Equation 1, it may be seen that the user equipment selects a cell having a measured signal strength and quality value than a predetermined value. The predetermined value may be defined by the cell providing a service. Further, the parameters used in Equation 1 are broadcast through system information, and the user equipment receives these parameters and uses the parameters as cell selection references.

If the user equipment selects a cell satisfying a cell selection reference, the user equipment receives information necessary for an RRC idle state operation of the user equipment in the corresponding cell from the system information of the corresponding cell. After receiving all the information necessary for the RRC idle state operation, the user equipment sends a request for a service (e.g., originating call) to the network or stands by in an idle mode to receive a service (e.g., terminating call) from the network.

After the user equipment selects a cell through the cell selecting process, the strength or quality of a signal between the user equipment and the base station may be changed by a variation in the mobility of the user equipment or wireless environment. Accordingly, in case the quality of the selected cell is lowered, the user equipment may select another cell that provides better quality. As such, when re-selecting a cell, a cell providing better signal quality than that of the currently selected cell is generally selected. This process is referred to as cell reselection. The cell reselecting process aims to select a cell that provides the best quality to the user equipment in light of the quality of radio signals.

Besides the point of view of the quality of radio signals, the network may determine a priority order per frequency and may inform it to the user equipment. When receiving the priority order, the user equipment considers this priority order ahead of the radio signal quality reference in the cell reselecting process.

Hereinafter, a heterogeneous network is described.

Mere cell split of macro cells and micro cells cannot satisfy the demand for increasing data services. Accordingly, pico cells, femto cells, and wireless relays may be used to operate data services for small indoor/outdoor areas. Although small cells are not limited as having particular purposes, pico cells may be generally used in communication shadow areas that are not covered by macro cells alone or areas with a lot of demand for data services, so-called “hot zones.” Femto eNBs may be generally used in indoor offices or homes. Further, wireless relays may back up coverage of macro cells. By configuring heterogeneous networks, shadow areas of data services may be eliminated, and transmission speed of data may be increased.

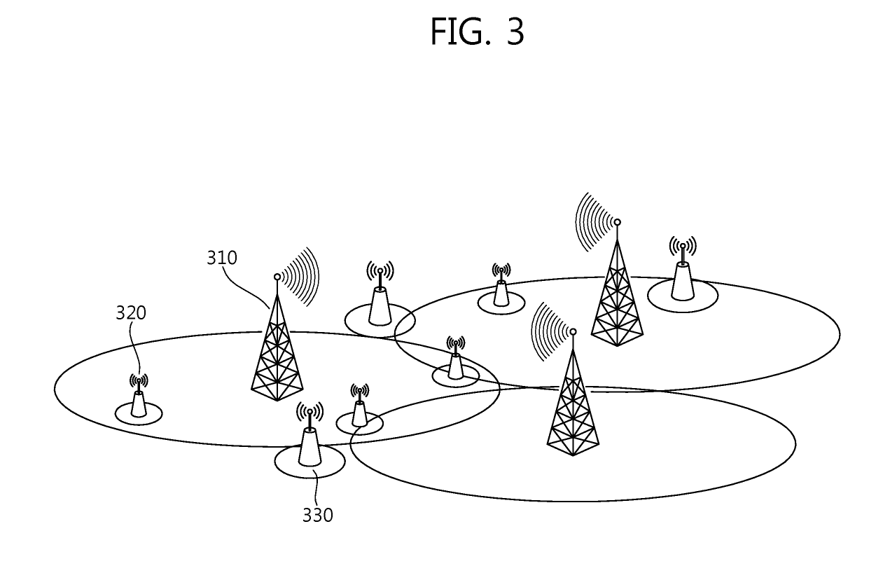

FIG. 3 is a view schematically illustrating the concept of a heterogeneous network that is constituted of macro base stations, femto base stations, and pico base stations according to the present invention. In FIG. 3, for ease of description, a heterogeneous network consisting of macro base stations, femto base stations, and pico base stations is described. However, the heterogeneous network may also include relays or other types of base stations.

Referring to FIG. 3, in the heterogeneous network, a macro base station 310, a femto base station 320, and a pico base station 330 are operated together. The macro base station 310, the femto base station 320, and the pico base station 330 respectively provide their cell coverage, i.e., a macro cell, femto cell, and a pico cell, to the user equipment.

The femto base station 320 is a low-power wireless access point, e.g., a tiny base station for mobile communication used indoors like in an office or home. The femto base station 320 may access a mobile communication core network via the DSL or cable broadband of a home or office. The femto base station 320 is required to support self-organization functions. The self-organization functions are classified into a self-configuration function, a self-optimization function, and a self-monitoring function.

The self-configuration function enables a wireless base station to be installed on its own based on an initial installation profile without passing through a cell planning step. The self-configuration function needs to meet the following requirements. First, the femto base station 320 needs to be able to set up a secured link with a mobile operation and management network (MON) according to a network service operator's security policy. Second, a femto base station management system (HNB management system: HMS) and the femto base station 320 need to be able to initialize download and activation of software of the femto base station 320. Third, the femto base station management system needs to be able to initialize provision of a transport resource for the femto base station 320 to establish a signaling link with the PLMN. Fourth, the femto base station management system should provide the femto base station 320 with wireless network specific information that enables the femto base station 320 to be automatically set up as an operable state.

The self-optimization function optimizes a list of adjacent base stations by identifying the adjacent base stations and obtaining information and optimizes communication capacity and coverage depending on changes in subscribers and traffic. The self-monitoring function enables service performance not to deteriorate through collected information.

The femto cell may distinguish registered users from unregistered users and may permit only the registered users to access. The cell that permits only registered users to access is referred to as “closed subscriber group (hereinafter, “CSG”), and the cell that permits access of common users is referred to as “open subscriber group (hereinafter, “OSG”). These two types may be mixed up.

A base station that provides a femto cell service is referred to as HNB (Home NodeB) or HeNB (Home eNodeB) when it comes to 3GPP. The femto base station 320 basically aims to provide a specified service only to members who belong to the CSG. From the point of view of provision of services, when the femto base station 320 provides services only to the CSG group, the cell provided by the femto base station 320 is referred to as “CSG cell.”

Each CSG has its unique identifier that is referred to as “CSG ID.” The user equipment may have a list of CSGs to which the user equipment belongs, and such a list is referred to as a white list. What CSG is supported by the CSG cell may be identified by reading the CSG ID included in the system information. The user equipment that has read the CSG ID, only when the user equipment is a member of the corresponding CSG cell, that is, when a CSG corresponding to the CSG ID is included in the CSG whitelist, is deemed a cell that may gain access to the corresponding cell.

The femto base station 320 need not always allow the CSG user equipment to access. Further, according to the configurations of the femto base station 320, access of a user equipment that is not a CSG member is permitted as well. What user equipment is allowed to access varies depending on the configuration of the femto base station 320. Here, the configuration means the configuration of an operation mode of the femto base station 320. The femto base station 320 has following three operation modes depending on what user equipment is to be serviced.

1) Closed access mode: provides a service to a particular CSG member. The femto base station 320 provides a CSG cell.

2) Open access mode: provides a service to, e.g., a common BS, without the restriction that it needs to be a particular CSG member. The femto base station 320 provides a general cell, but not a CSG cell.

3) Hybrid access mode: may provide a CSG service to a particular CSG member and may also provide a service to a non-CSG member of, e.g., a common cell. A CSG member UE is recognized as a CSG cell, and a non-CSG member UE is recognized as a common cell. This cell is called a hybrid cell.

In the heterogeneous network in which a femto cell is operated together with a macro cell, in case the femto cell is in an open access mode, a user may access a desired one of the macro cell and the femto cell to receive data services.

In case the femto cell is in, e.g., the closed access mode, a common user that uses the macro cell cannot use the femto cell even when the macro cell is interfered by the femto cell that propagates a strong signal.

Macro base stations are connected to each other via an X2 interface. The X2 interface maintains the operation of seamless handover and lossless handover and supports the management of radio resources. Accordingly, the X2 interface plays a crucial role in inter-cell interference coordination (ICIC) between the macro base stations.

On the contrary, no interface, such as X2 interface, is provided between the macro base station and the femto base station 320. Thus, dynamic signaling is not performed between the macro base station and the femto base station 320.

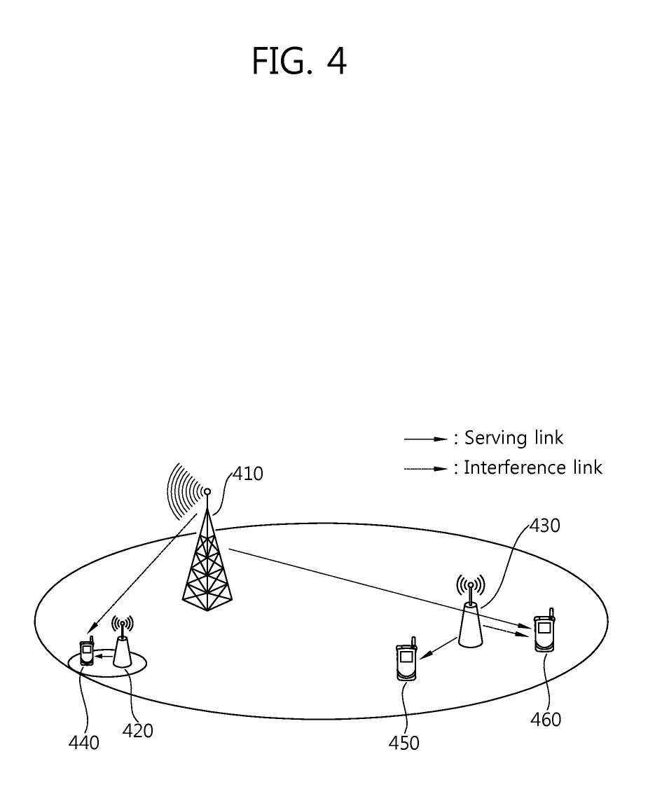

FIG. 4 is a view schematically illustrating an example in which user equipments are influenced by interference between a macro cell, a femto cell, and a pico cell on downlink.

Referring to FIG. 4, the user equipment 450 may access the fempto base station 430 to use a femto cell. However, if the fempto base station 430 is in the CSG mode, and the user equipment 460 that is positioned near the femto base station is not a registered user equipment of CSG, the user equipment 460 may not gain access the femto cell having a strong signal strength and ends up accessing the macro cell having a relatively weak signal strength as compared with the signal strength of the femto cell. Accordingly, in such case, the user equipment 460 may receive an interference signal from the femto cell.

Further, the user equipment 440 may access the pico base station 420 to use the pico cell. However, at this time, the user equipment 440 may be interfered by signals from the macro base station 410.

As such, a victim cell that is affected more by interference or needs to be further protected from the interference with respect to inter-cell interference between heterogeneous cells is the macro cell or pico cell. On the contrary, an aggressor cell that influences the victim cell with interference or is less influenced by interference is the femto cell.

A method of reducing inter-cell interference is inter-cell interference coordination (ICIC). In general, inter-cell interference coordination is a method for supporting reliable communication for a user belonging to a victim cell when the user is positioned near an aggressor cell. To coordinate inter-cell interference, for example, a restriction may be put to a scheduler for use of some time and/or frequency resources. Further, a restriction on how much power is to be used for particular time and/or frequency resources may be put to the scheduler.

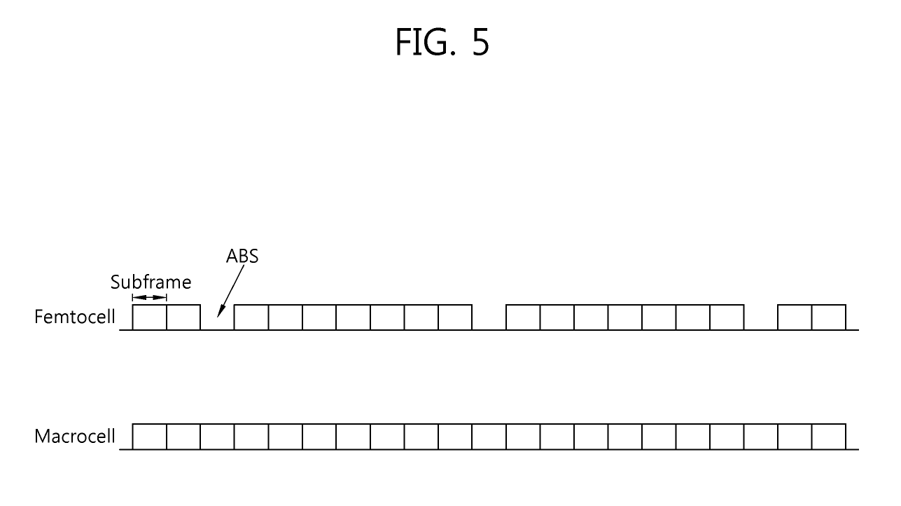

FIG. 5 is a view illustrating a frame pattern for inter-cell interference coordination in a heterogeneous network system according to an embodiment of the present invention. Here, the macro cell is a victim cell, and the femto cell is an aggressor cell.

Referring to FIG. 5, the frame pattern is configured so that no interference occurs between different types of cells (a macro cell and a femto cell). For example, in the sub-frame 3 of the macro cell, the macro cell transmits little signal and thus has very low transmission power. Accordingly, in such case, little signal is transmitted in the sub-frame. Thus, this sub-frame is referred to as an ABS (almost blank sub-frame). The ABS enables the femto cell to be used and is used to exclude interference with the macro cell. Here, the ABS is defined as a sub-frame that reduces the transmission power of control information, data information, and signaling (signals transmitted for channel measurement and sync) transmitted through the sub-frame or performs no transmission. Or, the ABS may also be defined as a sub-frame that is configured to have controlled transmission power among sub-frames defined considering interference with a heterogeneous eNB. Of course, it should be able to transmit system information, signaling, data information, and control information necessary for the user equipment to have backwards compatibility. The pattern to which the ABS is applied is referred to as an ABS pattern, and the ABS pattern may be configured, e.g., on a per-40 ms basis. Or, the ABS is formed to have a specific pattern in a wireless frame for interference coordination, and this is also referred to as a frame pattern. By using the frame pattern, the ABS within some periodic section constituted of multiple sub-frames is variably configured thereby coordinating interference.

The ABS pattern indicates, with a bitmap, whether a sub-frame corresponding to 40 ms is an ABS (ABS or non-ABS). For example, if a bit is 0, this indicates that its corresponding sub-frame is a non-ABS, and if the bit is 1, this indicates that the corresponding sub-frame is an ABS. Since the basic ABS pattern is 011001 . . . 01, sub-frames to which respective bits are mapped are sequentially non-ABS, ABS, ABS, non-ABS, non-ABS, ABS, . . . , non-ABS, and ABS.

The ABS is an inter-cell interference coordination scheme based on TDM (Time Division Multiplexing) in which heterogeneous cells respectively use split portions of a time resource, such as sub-frame. Interference may be coordinated by variably configuring the frame pattern structure itself within some periodic section constituted of multiple sub-frames.

Although in FIG. 5 for ease of description, a frame pattern for inter-cell interference coordination between the macro cell and the femto cell is shown, this is merely an example. The frame pattern shown in FIG. 5 may likewise apply between multiple cells including an aggressor cell and a victim cell or between multiple cells which have different coverage from each other. For example, the frame pattern of FIG. 5 may also apply to a macro base station and a pico base station. In such case, in FIG. 5, the macro base station may be replaced with the pico base station, and the femto base station may be replaced with the macro base station.

Hereinafter, a paging procedure is described. The paging procedure is generally separated into a radio paging procedure and an MME paging procedure. The radio paging procedure is a paging procedure performed on a user equipment by a base station. The radio paging procedure is used for the base station to transmit paging information to the user equipment that is in the RRC idle state, to inform a change in system information to the user equipment that is in the RRC idle state or connected state, to notify a primary ETWS (Earthquake and tsunami warning system) or a secondary ETWS, or to notify a CMAS (Commercial Mobile Alert System). The paging information is information for an RRC connection configuration for the user equipment to be able to receive an incoming call.

The MME paging procedure is used for an MME to page one user equipment that accesses the base station. In the MME paging procedure, the MME sends paging configuration information including a paging discontinuous reception (hereinafter, “DRX”) value and a list of CSG IDs to the base station. The paging DRX value is a DRX cycle specific to the user equipment, and the list of CSG IDs is a list including the CSG IDs. CSG cells that are not included in the CSG ID list do not transmit paging messages. When receiving the paging configuration information, the base station transmits a paging message to the user equipment based on the radio paging procedure.

The user equipment that is in the RRC idle state may perform the DRX operation to reduce power consumption. The user equipment may receive the paging message and the system information from the base station for a time promised with the base station and may receive no signals from the base station for the time other than the promised time. In order for the user equipment to be able to receive the paging signal among the information transmitted from the base station, the base station may control paging by configuring DRX parameters such as first paging occasion or paging frame.

The paging occasion (PO) is a sub-frame where a paging message is transmitted, and a P-RNTI (paging-radio network temporary identifier) indicating the paging message is scrambled in this sub-frame. The paging frame (PRF) is a radio frame that includes at least one paging occasion. The radio frame may include 10 sub-frames. If the user equipment is operated in DRX, the user equipment monitors only one paging occasion every DRX cycle.

Inter-heterogeneous cell interference may likewise occur even in the paging procedure between a macro cell and the user equipment. If a user equipment with no CSG membership is positioned in the coverage of a femto cell, a paging message of the macro cell may be interfered by a strong signal of the femto cell. Even when the macro base station and the femto base station operated based on the ABS pattern, interference to the paging message may not be completely removed. This is why if a discontinuous reception value differs from a per-user equipment IMSI value, a different paging frame or paging occasion is configured for each user equipment, and this may resultantly change the position of the sub-frame where paging occurs.

Accordingly, if inter-heterogeneous cell interference is present, the macro base station should control the paging frame or paging occasion so as to avoid the interference. First, a reference for determining whether inter-heterogeneous cell interference exists may be, e.g., whether the macro base station recognizes the femto base station or not. If the macro base station recognizes the femto base station, the macro base station may determine that inter-heterogeneous cell interference exists. On the contrary, if the macro base station fails to recognize the femto base station, the macro base station may determine that no inter-heterogeneous cell interference is present.

For coordination of inter-heterogeneous cell interference, the macro base station may control paging or an operation and management device may change the ABS pattern so that the ABS is further increased. However, as the ABS is increased, the throughput of the femto base station may be decreased. Controlling paging includes adjusting the position of a radio frame or sub-frame where paging occurs or adjusting the frequency of occurrence of paging. If the macro base station changes parameters associated with the paging frame or paging occasion, the position of the frame or sub-frame where paging occurs and the frequency of occurrence of paging may be adjusted.

In a TDD (Time Division Duplex) system in which uplink transmission and downlink transmission, respectively, are performed for different times from each other, the same sub-frame configuration should apply between the macro cell and the femto cell or between the macro cell and the pico cell. Accordingly, all the user equipments in the macro cell, pico cell, and femto cell should receive system information such as paging messages and SIB1 (System Information Block1) in the sub-frame that is positioned at the same location. Paging messages or system information are transmitted through a physical downlink shared channel (PDSCH).

To receive the paging message or system information, a PDCCH that is a control channel indicating the PDSCH including the paging message or system information should be first received. If a pico cell transmits PDCCH1 for user equipment A while a macro cell transmits PDCCH2 for user equipment B in the same sub-frame, user equipment A is interfered by PDCCH2. This is why the heterogeneous cells perform communication based on different cell IDs and individually transmit paging or system information.

Accordingly, an aggressor cell sets a particular sub-frame as an ABS and restricts transmission of the PDCCH not to interfere with a victim cell. For example, since the sub-frame set as the ABS is dominantly used by the victim cell, the aggressor cell does not the PDCCH in the sub-frame that is the ABS. However, the aggressor cell may still transmit the PDSCH even in the sub-frame that is the ABS. However, the PDSCH should be transmitted on a frequency band that does not interfere with the victim cell according to a predetermined rule or a negotiation between the aggressor cell and the victim cell.

In other words, the aggressor cell may transmit the PDCCH in the sub-frame that is a non-ABS. In the sub-frame that is an ABS, the PDCCH is not transmitted, and the PDSCH may be transmitted. According to a combination of these two conditions, the aggressor cell may transmit the PDCCH in the sub-frame that is the non-ABS and may transmit the PDSCH in the sub-frame that is the ABS. In such case, the PDCCH and the PDSCH being transmitted in different sub-frames from each other, not in the same sub-frame—so-called, sub-frame separation—occurs. Since due to the sub-frame separation, the PDCCH and PDSCH associated with each other are positioned in different sub-frames from each other, the positions of the associated PDCCH and PDSCH should be informed to the user equipment. Here, the PDCCH and PDSCH being associated with each other refers to when the PDCCH includes downlink control information (DCI) regarding the PDSCH.

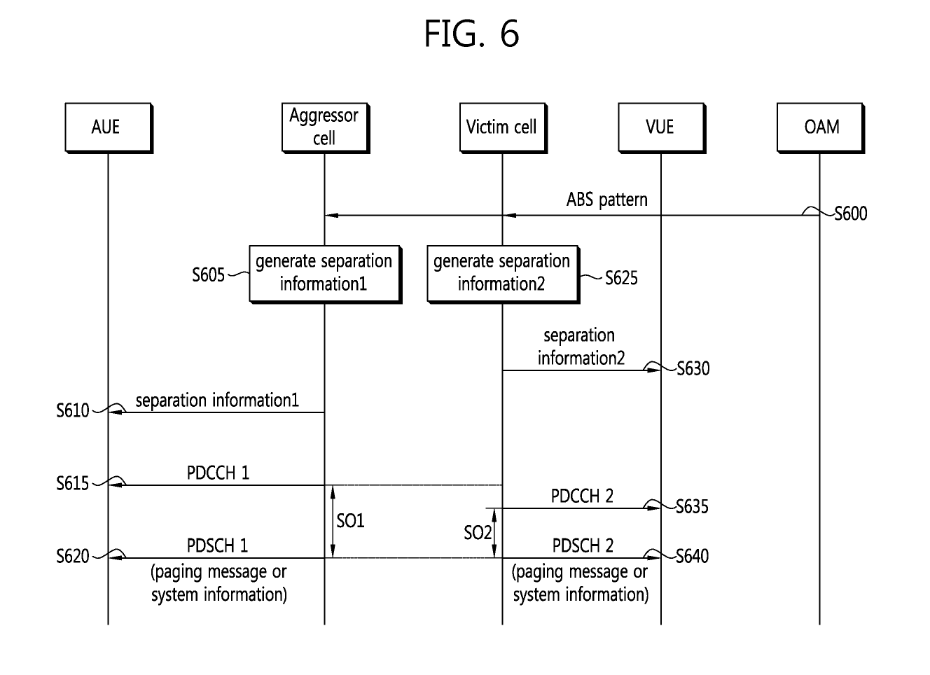

FIG. 6 is a flowchart illustrating a method of transmitting control information for coordinating inter-heterogeneous cell interference according to an embodiment of the present invention.

Referring to FIG. 6, a user equipment (AUE) is a user equipment that is connected with an aggressor cell. A user equipment (VUE) is a user equipment that is connected with a victim cell. Here, the user equipment (AUE) and the user equipment (VUE) both are assumed to stay camping on the aggressor cell and the victim cell, respectively, via a cell selecting procedure. From the point of view of interference between the macro cell and the femto cell, the aggressor cell may be the femto cell, and the victim cell may be the macro cell. Further, in light of interference between the macro cell and the pico cell, the aggressor cell may be the macro cell, and the victim cell may be the pico cell. The OAM is an operation and maintenance device that is in charge of operation and management of the aggressor cell or victim cell.

The operation and management device configures an ABS pattern of the aggressor cell based on ABS patterns of cells including the aggressor cell or cells neighboring the aggressor cell and whether they are synced with each other and transmits the ABS pattern of the aggressor cell to each of the aggressor cell and the victim cell (S600).

The aggressor cell analyzes the mechanism in which the associated PDCCH and PDSCH are sub-frame separated according to the ABS pattern of the aggressor cell and generates separation information 1 that indicates a relative distance (hereinafter, referred to as ‘inter-sub-frame distance’) between sub-frames that have associated PDCCH and PDSCH (S605). The aggressor cell transmits separation information 1 to the user equipment (AUE) (S610).

By way of example, separation information 1 may have the ABS pattern. For example, the aggressor cell may include the ABS pattern that is now being applied in the system information as a bitmap (e.g., 40 bits long) and may transmit the system information to the user equipment (AUE) that is in the RRC idle state.

The user equipment (AUE) identifies the DRX-related parameters and ABS patterns of the aggressor cell. If the sub-frame n is an ABS, the sub-frame n may become a paging occasion of the user equipment (AUE). At this time, the paging message is transmitted over the PDSCH of the sub-frame n. However, since the sub-frame n is an ABS, the PDCCH might not be transmitted. In such case, due to sub-frame separation, the PDCCH may be transmitted in the sub-frame (n−k) that is closest among the previous non-ABS sub-frames. In such case, the relative distance between the sub-frames having the associated PDCCH and PDSCH becomes k sub-frames. Accordingly, the user equipment (AUE) performs a DRX operation based on the sub-frame (n−k). That is, the user equipment (AUE) receives the PDCCH in the sub-frame (n−k) and receives the PDSCH of the sub-frame n using the received PDCCH. The aggressor cell also identifies the distance between sub-frames in the same way as the user equipment (AUE) does and accordingly performs a paging procedure on the user equipment (AUE).

As such, even if separation information 1 has an ABS pattern, the user equipment (AUE) may be implicitly aware of the distance between sub-frames by analyzing the ABS pattern. Separation information 1 may be transmitted on a broadcast channel (BCCH). Although in the above example separation information 1 applies to the paging procedure, this is merely an example, and separation information 1 may also apply to a procedure of transmitting system information, such as SIB1.

As another example, separation information 1 may explicitly indicate the distance between sub-frames. Separation information 1 refers to a difference k between the sub-frame (n−k) where scheduling information regarding a paging message (or system information) is transmitted and the sub-frame n where the paging message (or system information) is transmitted. Here, the scheduling information regarding the paging message is downlink control information (DCI) and is transmitted on the PDCCH of the sub-frame (n−k), and the paging message is transmitted on the PDSCH of the sub-frame n. To configure separation information 1, the aggressor cell may consider the ABS pattern.

Separation information 1 may be transmitted on a broadcast channel such as a physical broadcast channel (PBCH). Separation information 1 may indicate only the difference, k, between the sub-frame (n−k) where scheduling information regarding system information is transmitted and the sub-frame n where the system information is transmitted. Separation information 1 may include one bit (0 or 1) or two bits (0 through 3). The distance between sub-frames, in case the inter-heterogeneous cell interference coordination (ICIC) is disabled, is set as 0, and in case the inter-heterogeneous cell interference coordination is enabled, may be set as a value other than 0.

The aggressor cell transmits PDCCH1 to the user equipment (AUE) in the sub-frame (n−k) that is set as a non-ABS (S615). In case PDCCH1 includes scheduling information regarding a paging message, P-RNTI (Paging-Radio Network Temporary Identifier) is scrambled in CRC (Cyclic Redundancy Check) information of PDCCH1. A specific RNTI being scrambled in the CRC information of the PDCCH1 is also referred to as the RNTI being masked in the CRC information of the PDCCH1. The user equipment uses a P-RNTI when intending to receive paging in performing blind decoding on PDCCH1. Further, when intending to receive system information, the user equipment uses an SI-RNTI. In case PDCCH1 includes scheduling information regarding system information, the SI-RNTI (System Information-RNTI) is scrambled in the CRC information of the PDCCH1.

Table 1 shows an example of downlink control information (DCI) included in PDCCH1. This is DCI format 1A that is used for performing simple scheduling on one PDSCH code word.

```
TABLE 1
- Localized/Distributed VRB assignment flag - 1 bit
- Resource block assignment - ┌log₂(N_{RB}^{DL}(N_{RB}^{DL} +1)/2)┐ bits
- For localized VRB:
┌log₂(N_{RB}^{DL}(N_{RB}^{DL} +1)/2)┐ bits provide the resource allocation
- For distributed VRB:
- If N_{RB}^{DL} <50 or if the format 1A CRC is scrambled by RA-RNTI, P-RNTI, or SI-RNTI
- ┌log₂(N_{RB}^{DL}N_{RB}^{DL} +1)/2)┐ bits provide the resource allocation
- Else
- 1 bit, the MSB indicates the gap value, where value 0 indicates N_{gap} = N_{gap,1} and
value 1 indicates N_{gap} = N_{gap,2}
- (┌log₂(N_{RB}^{DL}(N_{RB}^{DL} +1)/2)┐ −1) bits provide the resource allocation,
- Modulation and coding scheme (MCS) - 5bits
- HARQ process number - 3 bits (FDD) , 4 bits (TDD)
- If the format 1A CRC is scrambled with a RA-RNTI, P-RNTI, or SI-RNTI
- At least 1 bit for HARQ process number indicates scheduling offset for paging or
SIB1.
- New data indicator - 1 bit
    - If the format 1A CRC is scrambled by RA-RNTI, P-RNTI, or SI-RNTI:
- If N_{RB}^{DL} ≧50 and Localized/Distributed VRB assignment flag is set to 1
- the new data indicator bit indicates the gap value, where value 0 indicates N_{gap} = N_{gap,1}
and value 1 indicates N_{gap} = N_{gap,2}.
        - Else the new data indicator bit is reserved.
    - Else
        - The new data indicator bit
- Redundancy version - 2 bits
- TPC command for PUCCH - 2 bits
    - If the format 1A CRC is scrambled by RA-RNTI, P-RNTI, or SI-RNTI:
        - The most significant bit of the TPC command is reserved.
        - The least significant bit of the TPC command indicates column N_{PRB}^{1A}
of the TBS table
        - If least significant bit is 0 then N_{PRB}^{1A} = 2 else N_{PRB}^{1A} = 3.
    - Else
        - The two bits including the most significant bit indicates the TPC
command
- Downlink Assignment Index (DAI) - this field is present in TDD for all the uplink -
downlink configurations and only applies to TDD operation with uplink -downlink
configuration 1-6. This field indicates scheduling offset for paging or SIB1 in FDD) - 2
bits
```

Referring to Table 1, DCI format 1A contains various control information necessary for controlling downlink. In particular, the HARQ process number field has three bits assigned in the FDD system and four bits assigned in the TDD system. However, in case the CRC information of PDCCH1 is scrambled in the RA-RNTI, P-RNTI or SI-RNTI, at least one bit of the three bits (in case of FDD) or four bits (in case of TDD) of the HARQ process number field indicates a scheduling offset (SO) for paging or SIB1. That is, the HARQ process number field of DCI format 1A is sometimes interpreted as a scheduling offset. In such case, a range of the scheduling offset values may be from 0 to 7 (FDD/TDD) or from 0 to 15 (TDD only).

Meanwhile, the downlink assignment index (DAI) is used only in the TDD system, but not used in the FDD system. Accordingly, in the case of the FDD system, at least one of three bits of the downlink assignment index field indicates the scheduling offset for paging or SIB1.

Scheduling offset1 indicates distance m between the received sub-frame (n−k) where PDCCH1 is received and a sub-frame in which a scheduled PDSCH is present. In other words, scheduling offset1 indicates the distance between a sub-frame, which is a non-ABS, where the PDCCH is transmitted and a sub-frame, which is an ABS positioned closest to the non-ABS after the non-ABS. Accordingly, the sub-frame where the PDSCH scheduled by PDCCH1 is present is the sub-frame (n−k+m). Here, k may be equal to m. In such case, the sub-frame in which the PDSCH scheduled by PDCCH1 is present is the sub-frame n. Hereinafter, for ease of description, it is assumed that m=k. The scheduling offset may also be referred to as an “inter-Sub-frame Scheduling Offset (ISSO).”

In step S615, it appears that only PDCCH1 is transmitted in the sub-frame (n−k). However, this is merely an example, and a number of PDCCHs having different purposes may be transmitted in one sub-frame. For example, PDCCH1-1 and PDCCH1-2 may be transmitted in the sub-frame (n−k). PDCCH1-1 may include a scheduling offset for paging, and PDCCH1-2 may include a scheduling offset for system information.

DCI format 1A may further include a data offset that is information for a sub-frame where actual data is to be transmitted. The data offset may apply to a user equipment that is in the RRC connected state. The data offset may be additionally configured as a new field in the existing DCI format, or in case a scheduling offset bit remains, the remaining bit may be used to configure the data offset. The data offset has one bit and may indicate on/off. The data offset may be also transmitted as system information or an RRC message.

The aggressor cell transmits a paging message or system information to the user equipment (AUE) on PDSCH1 of the sub-frame n designated by scheduling offset1 (SO1) (S620). Here, the sub-frame n is set as an ABS. The aggressor cell may use FDM-based inter-heterogeneous cell interference coordination (ICIC) so that the paging message or system information of the aggressor cell does not interfere with the paging message or system information of the victim cell. For example, if the victim cell transmits the paging message or system information using resource blocks (RBs) of indexes 10 to 20, the aggressor cell may transmit the paging message or system information using indexes 30 to 40.

Since the user equipment is already aware of scheduling offset1 previously received from the downlink control information of PDCCH1, the user equipment may know a sub-frame where PDSCH1 is to be transmitted. Accordingly, the user equipment may receive the paging message or system information transmitted on PDSCH1 based on the DCI of PDCCH1.

Steps S605 to S620 are a procedure for preventing the paging message or system information between the aggressor cell and the user equipment (AUE) from interfering with the victim cell, while steps S625 to S640 is a procedure for defending the victim cell from being interfered by the aggressor cell. In particular, the user equipment (VUE) positioned near a cell edge of the victim cell, in the CRE (Cell Range Extension) or in an area where the service area of the aggressor cell overlaps the service area of the victim cell may receive a weak signal from the victim cell as compared with a signal from the aggressor cell, and thus, the user equipment (VUE) may be prone to be interfered by the aggressor cell in the sub-frame that is a non-ABS. For example, the PDCCH of the aggressor cell may interfere with the PDCCH of the victim cell in the sub-frame that is a non-ABS. Accordingly, the victim cell transmits the PDSCH in the sub-frame that is a non-ABS while restricting transmission of the PDCCH, and the victim cell transmits the restricted in the sub-frame that is a previous ABS. That is, the victim cell also undergoes sub-frame separation. Thus, the victim cell also needs to provide the user equipment (VUE) with a scheduling offset or separation information indicating the distance between sub-frames as the aggressor cell does.

In steps S605 to S620, the transmission of the PDCCH of the aggressor cell in the sub-frame that is an ABS is restricted, but in steps S625 to S640, the transmission of the PDCCH of the victim cell in the sub-frame that is a non-ABS is restricted. In other words, in the sub-frame that is a non-ABS, the PDCCH of the aggressor cell is transmitted, and in the sub-frame that is an ABS, the PDCCH of the victim cell is transmitted. However, the victim cell is the same as the aggressor cell in light of the generation, transmission, and processing methods of the separation information and scheduling offset.

For example, the victim cell receives an ABS pattern from the operation and management device (600), analyzes the ABS pattern, and generates separation information2 (S610). Separation information2 may be an ABS pattern like separation information1. Or, separation information2 may explicitly indicate the distance between the sub-frame where the paging message or SIB1 is transmitted and the sub-frame where the PDCCH related thereto is transmitted.

The victim cell transmits PDCCH2 in the sub-frame (n−p) that is an ABS (S630). Here, n≠p. Accordingly, PDCCH2 is transmitted at a different time from the time when PDCCH1 is transmitted. This is why the aggressor cell is restricted to transmit PDCCH1 only in the sub-frame (n−k) that is a non-ABS. Pdc2 includes downlink control information as in Table 1, and the downlink control information includes a scheduling offset (SO)2. The scheduling offset2 indicates the distance between the (n−p)th frame where PDCCH2 is transmitted and the sub-frame n where PDSCH2 is transmitted.

Although PDCCH1 and PDCCH2 are transmitted in different sub-frames from each other, the paging messages and system information should be transmitted in the same sub-frame for all the user equipments (AUE, VUE) in the TDD system. Accordingly, PDSCH1 and PDSCH2 both are transmitted in the same sub-frame n (S640).

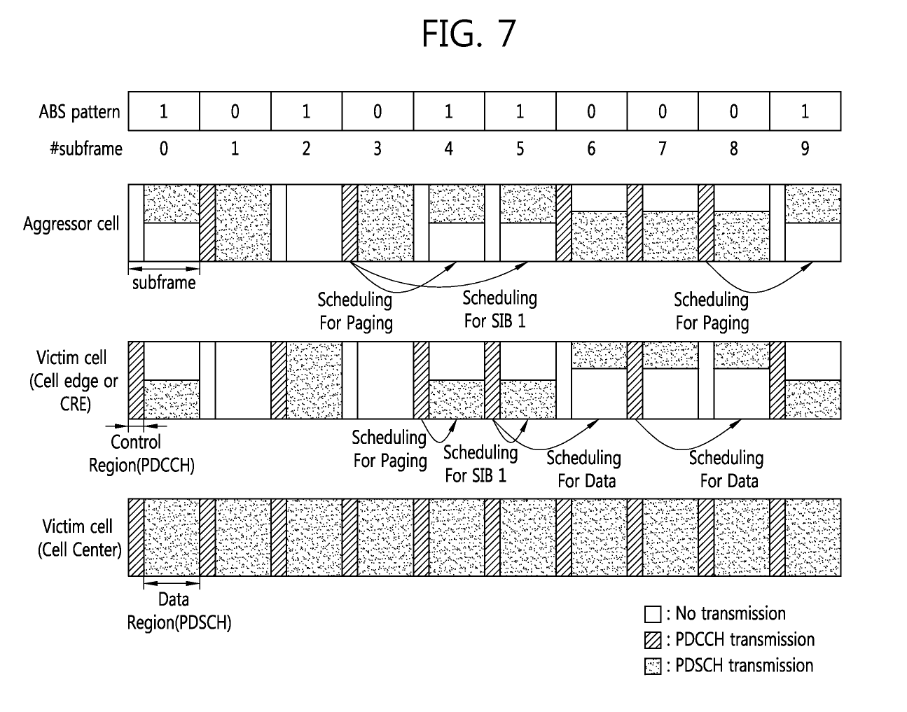

FIG. 7 illustrates an example to which a method of transmitting control information for coordinating inter-heterogeneous cell interference is applied according to the present invention.

Referring to FIG. 7, the ABS pattern is relates to an aggressor cell. The ABS pattern until sub-frames 0-9 is 1010110001, and if ‘1,’ the corresponding sub-frame is an ABS while if ‘0,’ the corresponding sub-frame is a non-ABS. Of course, what 0 and 1 mean may be opposite to each other. As described above, in the sub-frame that is an ABS, the PDCCH transmission of the victim cell is restricted so as to protect PDCCH transmission of the victim cell from interference in the sub-frame that is an ABS. Accordingly, the aggressor cell sets the sub-frame corresponding to all the paging occasions as the ABS so as to protect the PDCCH transmission of the paging and system information of the victim cell. However, the aggressor cell should also transmit paging messages to the user equipments (AUE) and thus transmits a PDSCH for paging message to the sub-frame that is an ABS. Even in the sub-frame that is an ABS, the paging and system information of the aggressor cell may be still transmitted.

Since sub-frame separation occurs, the paging of the aggressor cell in the sub-frame 4 that is an ABS is scheduled by PDCCH1 that is positioned in the sub-frame 3 that is a non-ABS. This means that the downlink control information (DCI) of PDCCH1 positioned in the sub-frame 3 includes a scheduling offset value, 1. On the other hand, the paging of the aggressor cell in the sub-frame 9 that is an ABS is scheduled by the PDCCH positioned in the sub-frame 8 that is a non-ABS. The scheduling of SIB1 of the aggressor cell in the sub-frame 5 that is an ABS is performed by PDCCH2 positioned in the sub-frame 3 that is a non-ABS that is previously closest. This means the downlink control information (DCI) of PDCCH2 positioned in the sub-frame 3 includes a scheduling offset value, 2.

Meanwhile, the victim cell also should perform inter-cell interference coordination in the sub-frame that is a non-ABS. This is why user equipments (VUE) positioned near an edge area of the victim cell or CRE region may be interfered by the sub-frame that is a non-ABS of the aggressor cell. Accordingly, the victim cell transmits no signal in the sub-frames 1 and 3 near the edge area of the victim cell. Meanwhile, the sub-frames 6, 7, and 8 to which FDM-based inter-heterogeneous cell interference coordination (ICIC) is applied are non-ABSs but scheduling therein is restricted for some data bands (or RBs). Accordingly, the victim cell may be scheduled for the band that is not used by the aggressor cell.

Although FDM-based inter-heterogeneous cell interference coordination applies, the frequency resources of the PDCCH might not be restricted. In other words the interference coordination for frequencies of the PDCCH departs from the range in which the FDM-based inter-heterogeneous cell interference coordination applies. In such case, since heavy interference may be applied to the PDCCH of the victim cell, scheduling for the PDSCH of the sub-frame 6 is done by the PDCCH of the sub-frame 5. The user equipment VUE that is positioned at the center of the victim cell or receives a signal whose strength is similar to a signal at the center thereof may be used without any restriction on scheduling.

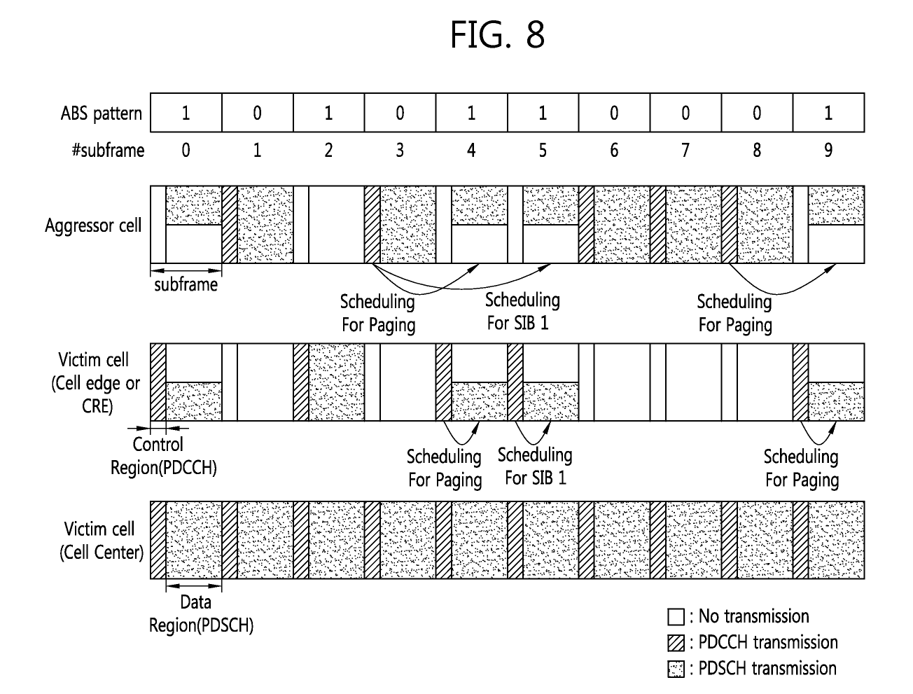

FIG. 8 illustrates another example to which a method of transmitting control information for coordinating inter-heterogeneous cell interference according to the present invention is applied.

Referring to FIG. 8, since backward compatibility should be maintained by the definition of ABS, the position of the sub-frame where the paging message and system information are transmitted should not be changed. Accordingly, the aggressor cell and victim cell positioned near the cell edge/CRE all transmit the paging message in sub-frames 4 and 9 that are ABSs and transmit the system information (SIB1) in the sub-frame 5. At this time, the aggressor cell and the victim cell occupy different frequency bands in the ABS section and the frequency band assigned to each cell remains static without change with time. This is achieved by a predetermined rule, and is the case where the information regarding the situation of using resources utilized in the FDM-based inter-cell interference coordination scheme is not shared between the aggressor cell and the victim cell.

However, since in the ABS, only the victim cell may transmit the PDCCH, the aggressor cell transmits the PDCCH in the sub-frame 3 that is a non-ABS and the victim cell transmits the PDCCH in the sub-frames 4, 5, and 9 that are ABSs.

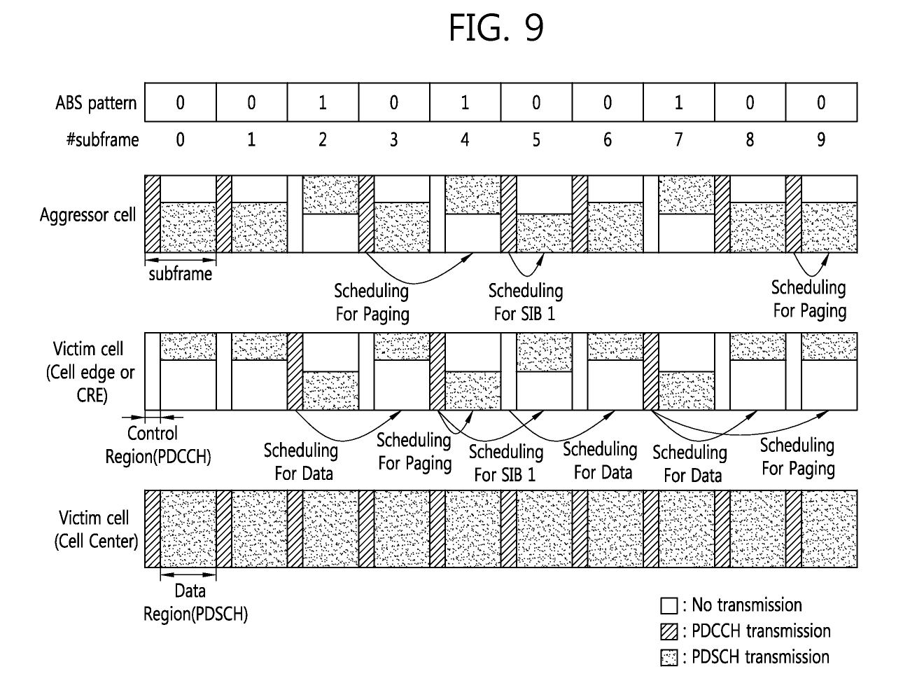

FIG. 9 illustrates another example to which a method of transmitting control information for coordinating inter-heterogeneous cell interference according to the present invention is applied.

Referring to FIG. 9, the aggressor cell and the victim cell near a cell edge or CRE occupy different frequency bands in the ABS. This is the case where information regarding the situation of using resources utilized in the FDM-based inter-cell interference coordination scheme is shared between the aggressor cell and the victim cell. Accordingly, the frequency band assigned to each cell is dynamically changed. The information regarding the situation of using the resources is a message transmitted/received between base stations to support the FDM-based inter-cell coordination scheme, and the information may be transferred through an X2 interface. Of course, in a wireless network including micro cells, pico cells, and femto cells, the FDM-based inter-cell coordination scheme may be supported between cells having inter-cell X2 interfaces.

The information of situation of use of resources includes the following three:

(1) RNTP (Relative Narrowband Transmit Power Indicator)

RNTP is indication information for downlink and is transmitted to neighboring base stations. Each of physical resource blocks (PRBs) that are basic units for indicating the frequency resource in the physical layer is denoted with one bit. For example, in case a base station sets a frequency bandwidth of 10 MB as the system frequency band, 50 PRBs are present, and the RNTP may be constituted of a total of 50 bits. If transmission power of each PRB is determined to be not less than a threshold at any time, one bit for the corresponding PRB is denoted as ‘1.’ Accordingly, if the neighboring base stations receive the RNTP, heavy interference may be determined to be likely to occur on the frequency resources of the PRBs denoted with ‘1 s.’

(2) HII (High Interference Indicator)

HII performs a similar operation to the RNTP that is information for downlink, but the HII is information for uplink transmission not for downlink. Like the RNTP, one bit is set for each PRB. The bit information becomes indication information on whether neighboring cells are to be heavily interfered in a near time. That is, the resources allocated to a user equipment positioned at a cell edge may heavily interfere with neighboring cells upon uplink transmission, and accordingly, bit information is set as ‘1,’ only for the PRBs generally allocated to the user equipment positioned at the cell edge, thus enabling this to be indicated.

Here, whether a user equipment is positioned at the cell edge may be identified based on a measured value of RSRP (Reference Signal Received Power) of handover measurement report.

(3) OI (Interference Overload Indicator)

RNTP information and HII information are indicators that previously indicate the situation of interference, but OI is triggered and transmitted to neighboring cells only when high interference in uplink is recognized by the base station. The OI may indicate three interference levels, including low, middle, and high, for each PRB depending on the degree of interference measured by the base station.

Referring back to FIG. 9, the aggressor cell configures the same RNTP regardless of ABS or configures the RNTP for ABS differently from the RNTP for non-ABS and transmits it to the victim cell. The victim cell, after receiving the RNTPs, does not allocate a resource to a frequency band through which high interference power is predicted to be received from the aggressor cell. Accordingly, a restriction is applied to scheduling of the frequency resource in the victim cell.

According to this, allocation of a frequency band to a heterogeneous cell is very flexible, so that the paging occasion sub-frame where paging occurs or the sub-frame where system information is transmitted is not necessarily set as an ABS. Accordingly, in case a user equipment in the victim cell receives a paging message, it may receive high interference power on the PDCCH. Thus, the victim cell sets an scheduling offset value and transmits the set scheduling offset to the user equipment that is in the RRC idle state through a broadcasting channel (e.g., PBCH).

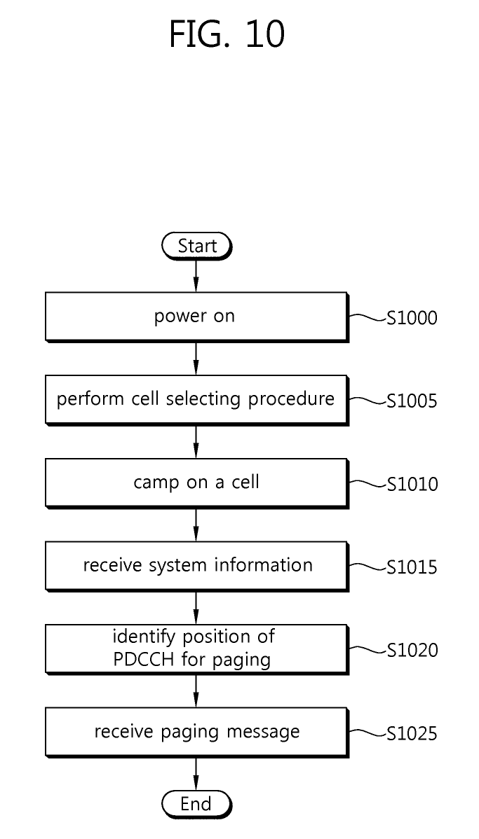

FIG. 10 is a flowchart illustrating a method of receiving control information for coordinating inter-heterogeneous cell interference by a user equipment according to an embodiment of the present invention.

Referring to FIG. 10, if a user powers on the user equipment (S1000), the user equipment performs a cell selecting procedure (S1005). The cell selecting procedure is the same as that described above in connection with FIG. 2. Thereafter, the user equipment camps on the selected cell (S1010). Here, the cell which the user equipment camps on may be an aggressor cell or a victim cell. Whichever cell the user equipment camps on, the user equipment may receive a paging message or system information for paging. Further, whether the user equipment camps on the aggressor cell or victim cell, the user equipment may receive scheduling information for receiving the paging message or system information, for example, downlink control information transmitted through a PDCCH or separation information transmitted through a broadcast channel.

The user equipment receives system information from the camped-on cell (S1015). The system information may include paging-related parameters as shown in Table 2.

```
TABLE 2
PCCH-Config ::= SEQUENCE {
    defaultPagingCycle (T value) ENUMERATED {
                            rf32, rf64, rf128, rf256},
    nB ENUMERATED {
                            fourT, twoT, oneT, halfT, quarterT,
                            oneEighthT,oneSixteenthT,
oneThirtySecondT}
}
```

The user equipment may perform the following procedure when identifying the system information. For example, the user equipment identifies a scheduling offset value for a PDCCH for scheduling the system information through a PBCH (step 1: step of identifying the scheduling offset for the system information). Then, the user equipment may identify the scheduling offset value for the PDCCH for scheduling paging through an SIB such as SIB2 (step 2-1: step of receiving the system information using the scheduling offset identified in step 1 and identifying the scheduling offset for paging in the received system information). Or the user equipment may receive ABS pattern information through an SIB such as SIB1, SIB2, or SIB4 (step 2-2: step of receiving the system information using the scheduling offset identified in step 1 and identifying the ABS pattern information in the received system information).

The user equipment identifies the position of the PDCCH for paging (S1020). Downlink control information as shown in Table 1 is transmitted on the PDCCH for paging, and the downlink control information includes the scheduling offset. The scheduling offset indicates, on a per-sub-frame basis, the distance between the sub-frame including the PDCCH for paging and the sub-frame including the PDSCH for the paging message.

The user equipment receives the paging message on the PDSCH of the sub-frame designated by the scheduling offset (S1025). In case the cell which the user equipment camps on is a victim cell, the PDCCH is received in the sub-frame that is an ABS. In contrast, when the cell which the user equipment camps on is an aggressor cell, the PDCCH is received in the sub-frame that is a non-ABS. Meanwhile, the user equipment may receive the PDSCH in the sub-frame that is an ABS or sub-frame that is a non-ABS because heterogeneous cells may occupy different frequency bands by FDM-based inter-cell coordination as shown in FIGS. 7 to 9.

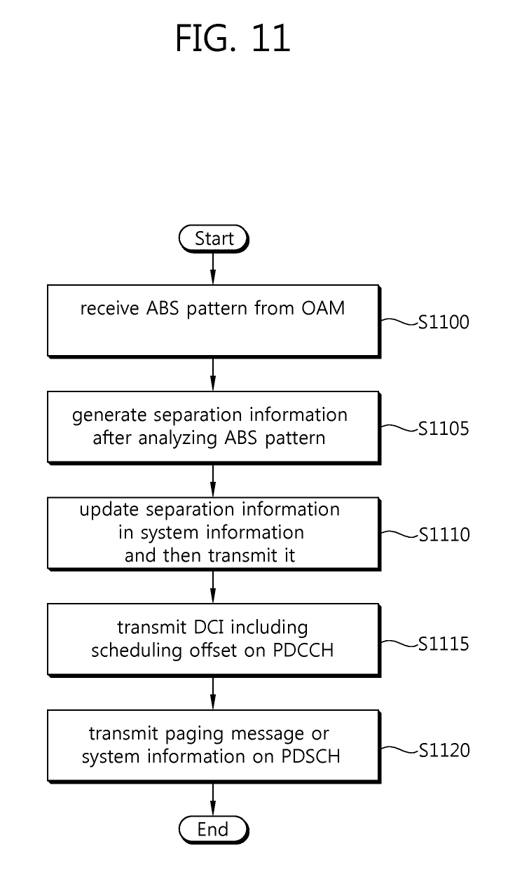

FIG. 11 is a flowchart illustrating a method of transmitting control information for coordinating inter-heterogeneous cell interference by an aggressor cell according to an embodiment of the present invention.

Referring to FIG. 11, the aggressor cell receives an ABS pattern from an operation and management device (OAM) (S1100). The received ABS pattern is one to be used in the current aggressor cell.

The aggressor cell analyzes the mechanism in which the associated PDCCH and PDCCH are sub-frame separated according to the ABS pattern and generates separation information that indicates the distance between sub-frames where the associated PDCCH and PDSCH are present (S1105). Here, the value of the separation information is k. The aggressor cell updates the separation information in the existing system information and transmits system information including the updated separation information to the user equipment (S1110).

The aggressor cell transmits downlink control information (DCI) including a scheduling offset containing k as shown in Table 1 on the PDCCH of the sub-frame (n−k) (S1115). At this time, the PDCCH is transmitted in the sub-frame that is a non-ABS.

The aggressor cell transmits the paging message or system information on the PDSCH in the sub-frame n (S1120). The PDSCH may be transmitted in the sub-frame that is an ABS or sub-frame that is a non-ABS because the heterogeneous cells may occupy different frequency bands by the FDM-based inter-cell coordination.

The paging message is transmitted based on the paging parameters as shown in Table 2. The paging parameters include a default paging cycle (defaultPagingCycle), a UE-specific paging cycle, a paging cycle T and nB.

The default paging cycle refers to a paging cycle cell-specifically set as default and is given any one of 32 radio frames (RF), 64 radio frames, 128 radio frames, and 256 radio frames.

The UE-specific paging cycle is a paging cycle individually set for each user equipment.

The paging cycle T is determined as the shorter one of the default paging cycle and the UE-specific paging cycle. If a higher layer (MME, RRC or NAS) does not separately configure the paging cycle T, T is determined as the default paging cycle.

nB is a paging parameter represented as a value obtained by multiplying the paging cycle T by a constant, and for example, may be selected as any one of 4T, 2T, T, T/2, T/4, T/8, T/16, and T/32.

By the above-described paging parameters, the paging frame and paging occasion may be determined. More specifically, the paging frame is determined by three paging parameters including DRX cycle, IMSI of the user equipment, and nB in case nB is set to be smaller than T. The paging occasion is determined only by IMSI of the user equipment if nB is smaller than T and is determined by both nB and IMSI if nB is equal to or larger than T.

The paging frame and the paging occasion are determined using the DRX parameters received through the system information of the cell which the user equipment camps on. First, Equation 2 is an example of a method of determining a paging frame:

$$SFN mod T = \frac{T}{N} \times ( UE ID mod N ) \qquad [ Equation 2 ]$$

Referring to Equation 2, SFN is a radio frame number and may be defined to have a value ranging from 0 to 1023 or from 1 to 1024. T is a paging cycle, and N=MIN(T, nB). That is, N is defined as the smaller one of T and nB. UE ID is defined in Equation 3:

UE ID=IMSI mod 1024 [Equation 3]

Here, in case the user equipment has no IMSI value, UE ID is set as 0. Next, Equation 4 is an example of a method of determining a paging occasion.

$$i\_s = ⌊ \frac{UE ID}{N} ⌋ mod Ns \qquad [ Equation 4 ]$$

Referring to Equation 4, i_s refers to a paging occasion of a sub-frame pattern as defined in Tables 2 and 3 below, and Ns=MAX(1, nB/T). That is, Ns is the larger one of 1 and nB/T. Accordingly, if nB/T<1, then Ns=1, and if nB/T>1, then Ns=nB/T. Table 3 applies to the FDD system, and Table 4 applies to the TDD system.

TABLE 3

| Ns | PO wheni_s = 0 | PO when i_s = 1 | PO when i_s = 2 | PO when i_s = 3 |
|---|---|---|---|---|
| 1 | 9 | N/A | N/A | N/A |
| 2 | 4 | 9 | N/A | N/A |
| 4 | 0 | 4 | 5 | 9 |

TABLE 4

| Ns | PO when i_s = 0 | PO when i_s = 1 | PO when i_s = 2 | PO when i_ s = 3 |
|---|---|---|---|---|
| 1 | 0 | N/A | N/A | N/A |
| 2 | 0 | 5 | N/A | N/A |
| 4 | 0 | 1 | 5 | 6 |

Referring to Tables 3 and 4, when Ns=1, the paging occasion (PO) is present only in one sub-frame. For example, the paging occasion is the sub-frame 9 in the case of FDD system and the sub-frame 0 in the case of TDD system. Meanwhile, when Ns=2, the sub-frames 4 and 9 in the case of FDD system and the sub-frames 0 and 5 in the case of TDD system are paging occasions.

For example, assume that nB=2T, T=64, and IMSI (decimal number)=5632. The paging frame is calculated as follows. According to Equations 3 and 4, the paging frame is (64/128)*((5632 mod 1024))mod 64)=0. Accordingly, SFN values, such as 0, 64, 128, 192, . . . , are paging frames.

Meanwhile, with respect to the TDD system, the paging occasion is calculated as follows. According to Equation 5, Ns=2, and i_s=0. When the user equipment performs DRX operation, the sub-frames 0 and 5 are paging occasions in 0, 64, 128, 192, . . . each paging frame.

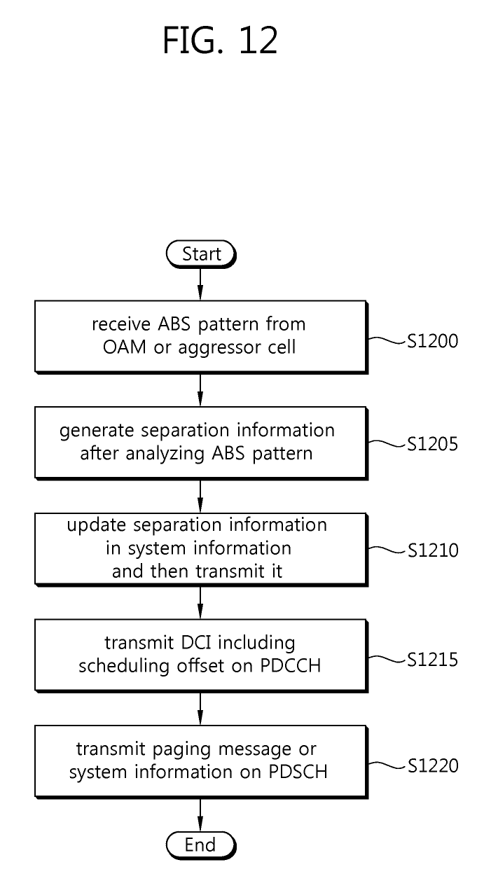

FIG. 12 is a flowchart illustrating a method of transmitting control information for coordinating inter-heterogeneous cell interference by a victim cell according to an embodiment of the present invention.

Referring to FIG. 12, the victim cell receives an ABS pattern from the operation and management device (OAM) or aggressor cell (S1200). The received ABS pattern is an ABS pattern to be used in the current aggressor cell.

The victim cell analyzes the mechanism in the associated PDCCH and PDSCH are sub-frame separated according to the ABS pattern and generates separation information to indicate the distance between sub-frames where the associated PDCCH and PDSCH are present (S1205). Here, the value of the separation information is p. The victim cell updates the separation information in the existing system information and then transmits it to the user equipment (S1210).

The victim cell transmits the downlink control information (DCI) including the scheduling offset having k as shown in Table 1 on the PDCCH of the sub-frame (n−p) (S1215). At this time, the PDCCH is transmitted in the sub-frame that is an ABS.

The victim cell transmits a paging message or system information on the PDSCH of the sub-frame n (S1220). The PDSCH may be transmitted in the sub-frame that is an ABS or sub-frame that is a non-ABS because the heterogeneous cells may occupy different frequency bands by FDM-based inter-cell coordination.

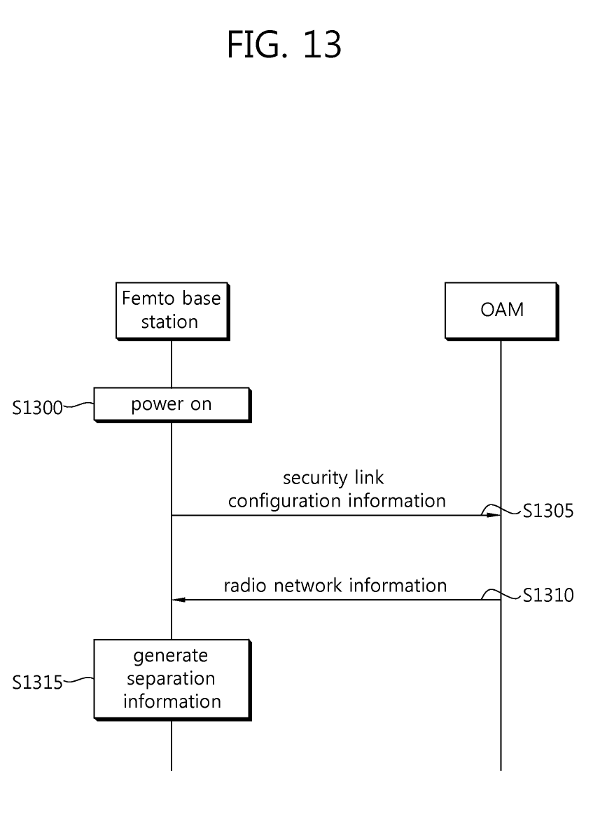

FIG. 13 is a flowchart illustrating signaling between a femto base station and an operation and management device according to an embodiment of the present invention.

Referring to FIG. 13, if the femto base station powers on (S1300), the femto base station transmits security link configuration information for configuring a security link with the operation and management device (OAM) (S1305). The security link is configured based on the information stored in a memory when the femto base station is shipped.

The operation and management device configures an ABS pattern of the femto base station based on whether base stations (e.g., macro base stations or pico base stations or femto base stations having different memberships) including the coverage of the femto base station or neighboring base stations (e.g., macro base stations or pico base stations or femto base stations having different memberships) of the femto base station are synchronized with the ABS pattern (S1310).

The operation and management device transmits wireless network information necessary for the femto base station to the femto base station (S1315). The wireless network information includes at least one of the ABS pattern and wireless configuration information. The wireless configuration information includes wireless parameters of an existing wireless environment for macro base stations including the coverage of the femto base station or macro base stations neighboring the femto base station.

The femto base station configures separation information for receiving paging or system information in the system information according to the ABS pattern (S1320).

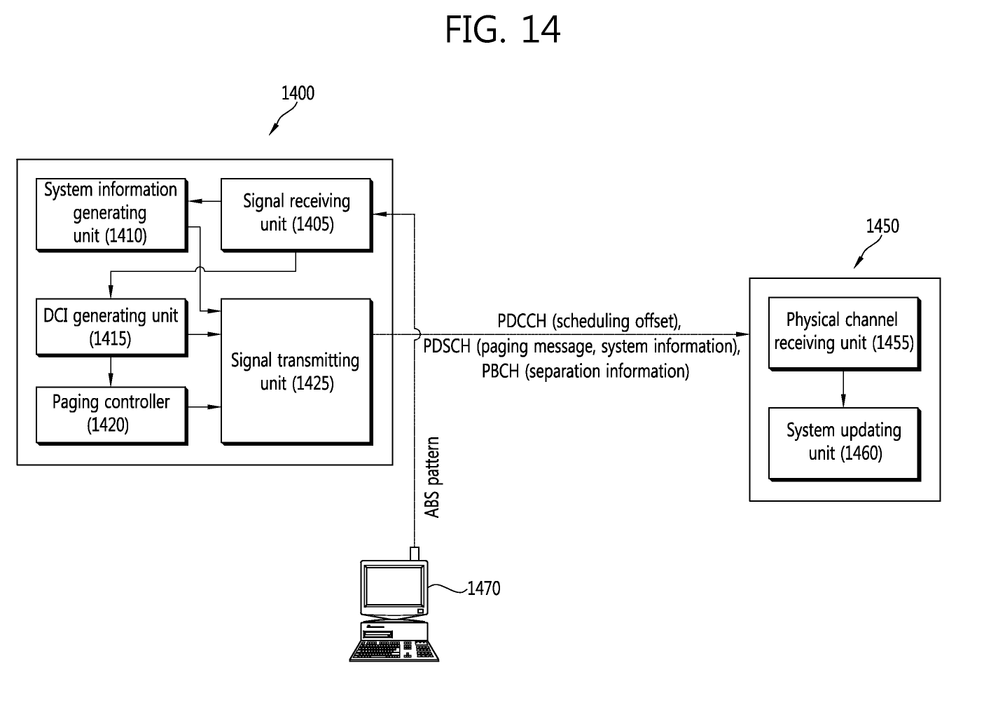

FIG. 14 is a block diagram illustrating a user equipment and a base station according to an embodiment of the present invention.

Referring to FIG. 14, the base station 1400 includes a signal receiving unit 1405, a system information generating unit 1410, a DCI generating unit 1415, a paging controller 1420, and a signal transmitting unit 1425. Here, the base station 1400 may be a victim base station (victim eNB) that provides a victim cell in a network that provides a heterogeneous cell or may be an aggressor base station (aggressor eNB) that provides an aggressor cell.

The signal receiving unit 1405 receives an ABS pattern from an operation and management device 1470 and sends the ABS pattern to the system information generating unit 1410 and the DCI generating unit 1415.

The system information generating unit 1410 analyzes the ABS pattern to generate separation information or to update separation information included in system information and generates system information including the generated or updated separation information. By way of example, the separation information may be the ABS pattern itself. For example, the system information generating unit 1410 determines a first sub-frame where a PDCCH is transmitted and a second sub-frame where a PDSCH scheduled by the PDCCH is transmitted based on the ABS pattern and may generate separation information to indicate a separated distance between the first sub-frame and the second sub-frame. Although the separation information is the ABS pattern, the user equipment 1450 may obtain he distance between the sub-frames by analyzing the ABS pattern. As another example, the separation information may indicate the distance between the sub-frames. The separation information indicates k that is a difference between the sub-frame (n−k) where scheduling information regarding a paging message (or system information) is transmitted and the sub-frame n where the paging message (or system information) is transmitted. Meanwhile, the system information may further include a paging-related parameter.

The DCI generating unit 1415 generates downlink control information (DCI) including a scheduling offset. The scheduling offset indicates the distance between sub-frames as the number of the sub-frames. The downlink control information may be DCI format 1A as shown in Table 1. The DCI generating unit 1415 may configure the downlink control information so that an HARQ process number field indicates the scheduling offset when generating the downlink control information for the paging message or system information. Or, the DCI generating unit 1415 may configure the downlink control information so that the downlink allocation index (DAI) field indicates the scheduling offset when generating the downlink control information for the paging message or system information. The DCI generating unit 1415 sends the generated downlink control information to the signal transmitting unit 1425 and sends the scheduling offset to the paging controller 1420.

The paging controller 1420 controls the signal transmitting unit 1425 so that the paging message may be transmitted in the paging occasion sub-frame determined based on the paging parameter such as shown in Table 2 of the scheduling offset received from the DCI generating unit 1415.

The signal transmitting unit 1425 transmits the downlink control information including the scheduling offset (=k) through the PDCCH of the sub-frame (n−k) to the user equipment 1450. The signal transmitting unit 1425 transmits broadcast information including separation information to the user equipment 1450 over a PBCH. The signal transmitting unit 1425 transmits a paging message or system information to the user equipment 1450 through the PDSCH of the sub-frame n.

The user equipment 1450 includes a physical channel receiving unit 1455 and a system updating unit 1460.

The physical channel receiving unit 1455 receives downlink control information including a scheduling offset indicating k through the PDCCH of the sub-frame (n−k), receives broadcast information including separation information through a PBCH, and receives a paging message or system information through a PDSCH of the sub-frame n. Here, if the sub-frame (n−k) is a sub-frame that is an ABS, the sub-frame n is a sub-frame that is a non-ABS (in case the user equipment 1450 accesses the victim cell). On the contrary, if the sub-frame (n−k) is a sub-frame that is a non-ABS, the sub-frame n is a sub-frame that is an ABS (in case the user equipment 1450 accesses the aggressor cell). Meanwhile, the physical channel receiving unit 1455 may receive the PDSCH in both the sub-frame that is an ABS and the sub-frame that is a non-ABS because the heterogeneous cells may occupy different frequency bands by FDM-based inter-cell coordination as shown in FIGS. 7 to 9.

The system updating unit 1460 identifies system information. For example, the system updating unit 1460 may perform the following procedure when identifying the system information. The system updating unit 1460 identifies a scheduling offset value for a PDCCH for scheduling the system information through a PBCH (step 1: step of identifying the scheduling offset for the system information). The system updating unit 1460 identifies the scheduling offset value for the PDCCH for scheduling paging through a SIB such as SIB2 (step 2-1: step of receiving system information using the scheduling offset identified in step 1 and identifying the scheduling offset for paging in the received system information). Or, the system updating unit 1460 receives ABS pattern information through an SIB such as SIB1, SIB2, or SIB4 (step 2-2: step of receiving system information using the scheduling offset identified in step 1 and identifying the ABS pattern in the received system information).

The system updating unit 1460 updates the system information using the separation information, identifies a distance between sub-frames from the scheduling offset, and then receives a paging message or system information from the base station 1400 accordingly.

In the above-exemplified systems, although the methods are described based on the flowcharts having a series of steps or blocks, the present invention is not limited to the order of the steps. Rather, some steps may be performed concurrently with or in a different order from other steps. Further, it will be understood by those skilled in the art that other steps may be included in the flowcharts or some of the steps of the flowcharts may be excluded without affecting the scope of the present invention.

The above-described embodiments include various aspects of examples. Although the embodiments do not include all possible combinations for representing various aspects, it will be understood by those skilled in the art that other combinations may be made. Accordingly, the present invention includes all other changes, modifications, and variations within the scope of the present invention as defined in the appended claims.

1. A base station transmitting control information for coordinating inter-heterogeneous cell interference, the base station comprising:
a signal receiving unit that receives an ABS (almost blank sub-frame) pattern configured to have transmission power controlled in a sub-frame determined considering interference with a heterogeneous eNB from an operation and management device that operates and manages the heterogeneous eNB;
a system information generating unit that determines a first sub-frame where a PDCCH (physical downlink control channel) is transmitted and a second sub-frame where a PDSCH (physical downlink shared channel) scheduled by the PDCCH is transmitted based on the ABS pattern and generates separation information to indicate a separated distance between the first sub-frame and the second sub-frame;
a downlink control information generating unit that generates downlink control information including a scheduling offset indicating the separated distance; and
a signal transmitting unit that transmits the downlink control information through the PDCCH in the first sub-frame and transmits a paging message or system information through the PDSCH in the second sub-frame.

2. The base station of claim 1, wherein the system information generating unit generates separation information indicating the separated distance as the number of sub-frames.

3. The base station of claim 1, where the downlink control information generating unit generates the downlink control information so that an HARQ (hybrid automatic repeat request) process number field included in the downlink control information indicates the scheduling offset.

4. The base station of claim 1, wherein the downlink control information generating unit generates the downlink control information so that a downlink allocation index (DAI) field included in the downlink control information indicates the scheduling offset.

5. The base station of claim 1, wherein in a case where the base station provides an aggressor cell that interferes with a neighboring base station, the system information generating unit determines a non-ABS as the first sub-frame and an ABS as the second sub-frame.

6. The base station of claim 1, wherein in a case where the base station provides a victim cell interfered by a neighboring base station, the system information generating unit determines an ABS as the first sub-frame and a non-ABS as the second sub-frame.

7. A method of transmitting control information for coordinating inter-heterogeneous cell interference by a base station, the method comprising:
receiving an ABS pattern configured to have transmission power controlled in a sub-frame determined considering interference with a heterogeneous eNB from an operation and management device that operates and manages the heterogeneous eNB;
determining a first sub-frame where a PDCCH is transmitted and a second sub-frame where a PDSCH scheduled by the PDCCH is transmitted based on the ABS pattern;
generating separation information to indicate a separated distance between the first sub-frame and the second sub-frame;
generating downlink control information including a scheduling offset indicating the separated distance;
transmitting the downlink control information through the PDCCH in the first sub-frame; and
transmitting a paging message or system information through the PDSCH in the second sub-frame.

8. The method of claim 7, wherein an HARQ process number field included in the downlink control information indicates the scheduling offset.

9. The method of claim 7, wherein the separated distance is defined as the number of sub-frames.

10. The method of claim 7, wherein a downlink allocation index (DAI) field included in the downlink control information indicates the scheduling offset.

11. The method of claim 7, wherein in a case where the base station provides an aggressor cell that interferes with a neighboring base station, the first sub-frame is determined as a non-ABS, and the second sub-frame is determined as an ABS.

12. The method of claim 7, wherein in a case where the base station provides a victim cell that is interfered by a neighboring base station, the first sub-frame is determined as an ABS, and the second sub-frame is determined as a non-ABS.

13. A user equipment receiving control information for coordinating inter-heterogeneous cell interference, the user equipment comprising:
a physical channel receiving unit that receives a PDCCH in a first sub-frame, receives a PDSCH indicated by the PDCCH in a second sub-frame, and receives separation information indicating a distance between the first sub-frame and the second sub-frame from a base station through a PBCH; and
a system updating unit that updates system information of the user equipment based on the separation information, wherein one of the first sub-frame and the second sub-frame is set as an ABS configured to have transmission power controlled in a sub-frame determined considering interference with a heterogeneous eNB, and the other is set as a non-ABS.

14. The user equipment of claim 13, wherein the physical channel receiving unit receives the PDSCH including a paging message or system information on the user equipment from the base station.

15. The user equipment of claim 13, wherein the physical channel receiving unit receives, from the base station, the PDCCH including an HARQ process number field indicating a distance between the first sub-frame and the second sub-frame.

16. The user equipment of claim 13, wherein in a case where the first sub-frame is an ABS, the base station provides the user equipment with a victim cell interfered by a neighboring base station.

17. The user equipment of claim 13, wherein in a case where the first sub-frame is a non-ABS, the base station provides the user equipment with an aggressor cell interfering with a neighboring base station.

18. A method of receiving control information for coordinating inter-heterogeneous cell interference by a user equipment, the method comprising:
receiving a PDCCH in a first sub-frame;
receiving a PDSCH indicated by the PDCCH in a second sub-frame;
receiving separation information indicating a distance between the first sub-frame and the second sub-frame through a PBCH from a base station; and
updating system information of the user equipment based on the separation information, wherein one of the first sub-frame and the second sub-frame is set as an ABS configured to have transmission power controlled in a sub-frame determined considering interference with a heterogeneous eNB and the other is set as a non-ABS.

19. The method of claim 18, wherein the PDSCH includes a paging message or system information on the user equipment.

20. The method of claim 18, wherein the PDCCH includes an HARQ process number field indicating a distance between the first sub-frame and the second sub-frame.

21. The method of claim 18, wherein in a case where the first sub-frame is an ABS, the base station provides the user equipment with a victim cell interfered by a neighboring base station.

22. The method of claim 18, wherein in a case where the first sub-frame is a non-ABS, the base station provides the user equipment with an aggressor cell interfering with a neighboring base station.
